(19) United States
(12) Patent Application Publication
(10) Pub. No.: US 2010/0091127 A1
(43) Pub. Date: Apr. 15, 2010

(54) IMAGE RECONSTRUCTION METHOD FOR A GRADIENT CAMERA

(75) Inventors: Peter HAMPTON, Victoria (CA); Panajotis AGATHOKLIS, Victoria (CA)

Correspondence Address: FASKEN MARTINEAU DUMOULIN LLP, 2900 - 550 Burrard Street, VANCOUVER, BC, V6C 0A3, CA

(73) Assignee: University of Victoria Innovation and Development Corporation, Victoria (CA)

(21) Appl. No.: 12/569,861

(22) Filed: Sep. 29, 2009

Related U.S. Application Data
(60) Provisional application No. 61/101,601, filed on Sep. 30, 2008.

(51) Int. Cl. H04N 5/228; G06K 9/40; H04N 5/222

(52) U.S. Cl. 348/222.1; 382/264; 348/333.01; 348/E05.031; 348/E05.022

(57) ABSTRACT

A method for reconstructing a digital image including: obtaining gradient data of the digital image, estimating the wavelet decomposition of the digital image based on the gradient data, performing a synthesis and smoothing operation on decomposed gradient data to provide an estimate of pixel intensities from the wavelet decomposition and outputting a reconstructed digital image.

### RELATED APPLICATION

This application claims benefit under 35 U.S.C. 119(e) of U.S. Provisional Patent Application Ser. No. 61/101,601, filed Sep. 30, 2008, entitled “IMAGE RECONSTRUCTION METHOD FOR A GRADIENT CAMERA”, which is incorporated herein by reference in its entirety.

### TECHNICAL FIELD

The present invention relates to image reconstruction, in particular, image reconstruction using gradient data from a raw scene.

### BACKGROUND

In order to enable image formation, cameras and other image-capturing devices typically use pixel intensity data to reconstruct the image. In some applications, images are reconstructed from gradient measurement data where static gradients, instead of static intensities, are measured and are used to reconstruct the image. By using gradient measurement data rather than pixel intensity data, saturation of the data is reduced because the local difference between two pixels is recorded rather than the intensity of each pixel. In photography, this relates to the higher dynamic range capability of a camera where one can be able to capture high contrast scenes without under-exposing or over-exposing certain features on the scene.

One method for image reconstruction uses an iterative Poisson solver to convert the gradient data to an estimate of the image. This method is the subject in the IEEE Computer Society Conference on Computer Vision and Pattern Recognition 2005 publication entitled “Why I want a gradient camera” by J. Tumblin, A. Agrawal and R. Raskar. Another conventional approach uses a combination of Fourier transforms. These techniques are computationally intensive.

It is therefore desirable to provide a method for reconstructing an image that produces a high quality image with a relatively low computational cost.

### SUMMARY

The present invention provides an efficient and fast method of image reconstruction that can be used in image-displaying devices, such as view finders, for example, image-capturing devices, such as gradient cameras, for example, image-replicating devices, such as digital copiers for example, and in many other image processing applications. The present invention implements Haar wavelet decomposition, which provides lesser mathematical complexity and fewer mathematical operations resulting to fast generation of a high quality image.

In one aspect of the invention there is provided a method for reconstructing a digital image including: obtaining gradient data of the digital image; performing a first computer process to generate a wavelet decomposition of the digital image based on the gradient data and providing a first result to a second computer process; performing a synthesis and smoothing operation on decomposed gradient data in the second computer process to provide an estimate of pixel intensities from the wavelet decomposition; and outputting a second result of the second computer process; wherein the second result is a reconstructed digital image.

In another aspect of the invention there is provided an image-generating device, the device including: an image sensing device for generating a digital image; a processor in communication with the image sensing device, the processor for calculating gradient data based on the digital image, generating a wavelet decomposition of the digital image based on the gradient data and performing a synthesis and smoothing operation on decomposed gradient data to provide an estimate of pixel intensities from the wavelet decomposition; an image output device in communication with the processor for outputting a reconstructed digital image.

### DRAWINGS

The following figures set forth embodiments of the invention in which like reference numerals denote like parts. Embodiments of the invention are illustrated by way of example and not by way of limitation in the accompanying figures.

FIG. 1 is a flowchart showing a method of reconstructing a digital image according to an embodiment of the invention;

FIG. 1a is a functional block diagram of the method of reconstructing a digital image of FIG. 1;

FIG. 2 is a block diagram showing the Fried and Hudgin sensor geometries;

FIG. 3 is a schematic diagram showing Fried aligned sensor locations in which circles represent the sensors and squares represent image pixels;

FIG. 4 is a block diagram showing the relationship between Hudgin and Fried aligned gradient models;

FIGS. 5a to 5d are schematic diagrams showing the shapes that compose the 2-D Haar wavelet system;

FIG. 6 is a block diagram showing one stage of a Haar Wavelet Analysis Filterbank (HWAF);

FIG. 7 is a block diagram showing image decomposition using a HWAF;

FIG. 8 is a block diagram showing the structure of M-Stage Haar Filterbank;

FIG. 9 is a block diagram showing the structure of the HWSF;

FIGS. 10(a) to (d) are block diagrams showing the Conversion of the Haar Analysis Filter from a form that is recursive in the image intensity domain to being recursive in image gradient domain;

FIG. 11 is a block diagram showing one data structure of image decomposition obtained from gradient data;

FIG. 12 is a block diagram showing gradient Analysis Filterbank structure for HL, LH and LL quadrants;

FIG. 13 shows a block layout of the Gradient Analysis Filterbanks with Haar Synthesis Filterbanks structure;

FIG. 14a is a graph showing the full wave-front reconstruction image in which the color bar measures the magnitude of each pixel;

FIG. 14b is a graph showing the residual error when the HH quadrant is suppressed in which the color bar measures the magnitude of the error at each pixel;

FIG. 14c is a graph showing residual error from the full reconstruction in FIG. 14a in which the color bar measures the magnitude of the error at each pixel;

FIG. 15a is a graph showing Zernike coefficients of a wave-front;

FIG. 15b is a graph showing Zernike coefficients of error with Signal-to-noise ratio (SNR)=∞;

FIG. 15c is a graph showing Zernike coefficients of error with SNR=20;

FIG. 16 is a graph showing reconstruction error compared to the inverse of the SNR;

FIG. 17 is a graph showing the absolute value of the reconstruction errors from suppressing the HH quadrant;

FIG. 18 is an image having reconstruction from gradient data corrupted to SNR=2 (or 6 dB);

FIG. 19 is a graph showing reconstruction error for the 2048×2048 photograph vs. the inverse of SNR;

FIG. 20 is a block diagram of a method of reconstructing a digital image according to another embodiment of the invention, reduction in resolution may be (i) simple down sampling, or the analysis filters presented in this document;

FIG. 21 is a decomposition representation of gradient measurement signals;

FIG. 22(a) shows a reconstruction of an image;

FIG. 22(b) shows an example of data corruption in image reconstruction without a smoothing process;

FIG. 23 is a block diagram of a Gradient Analysis Filterbank implemented with polyphase techniques to minimize computation;

FIG. 24 shows an alternate naming convention for the decomposition structure for a Gradient Analysis Filterbank of FIG. 11;

FIG. 25 is a block diagram of a lifting realization of the 2-D Haar Synthesis filterbank;

FIG. 26 is a schematic diagram showing unused data so that measured data is converted to an estimate of the image pixels (squares) and redundant measurements (black circles);

FIG. 27 is a block diagram of lifting realization of slope averaging as a method of image smoothing;

FIG. 28 is a block diagrams showing connections to incorporate slope averaging as part of the synthesis process;

FIG. 29 is a block diagram showing a layout of 2-D integration of gradient measurements;

FIG. 30 is a graph showing computation time per pixel in a MatLab implementation example;

FIG. 31 is a representation of the power of the gradient analysis in dB;

FIG. 32 is a normalized power of FIG. 19 decomposition constructed from Gradient Analysis;

FIG. 33 is a noiseless reconstruction using Gradient Analysis, Haar Synthesis and Slope Averaging;

FIG. 34(a) is an image reconstructed from corrupted data without slope averaging;

FIG. 34(b) is an image reconstructed from corrupted data using slope averaging;

FIG. 35 is an image in which gradient data is coarsely estimated;

FIG. 36 is an example of a reconstructed color image;

FIG. 37 is an example of a reconstruction of a color image for a view finder;

FIG. 38 is an example of an image obtained using one of the public domain Fourier transform methods;

FIG. 39 is an example of an image obtained using a method according to an embodiment of the invention; and

FIG. 40 shows the error associated with FIGS. 38 and 39.

### DETAILED DESCRIPTION OF EMBODIMENTS OF THE INVENTION

In general, a method for image reconstruction from gradient measurement data using wavelets is provided that is order N floating point operations (flops), where N is the number of pixels. The approach is based on obtaining an estimate of the wavelet decomposition of the original image by filtering and down sampling the gradient measurement data.

The term “image” is used to denote the result of reversing the gradient process. It will be appreciated by a person skilled in the art that the process is not limited to images of visual scenes. The process may also be used for reconstructing the image of a wave-front of an electromagnetic field using data from a gradient wave-front sensor, such as in the field of Adaptive Optics (AO).

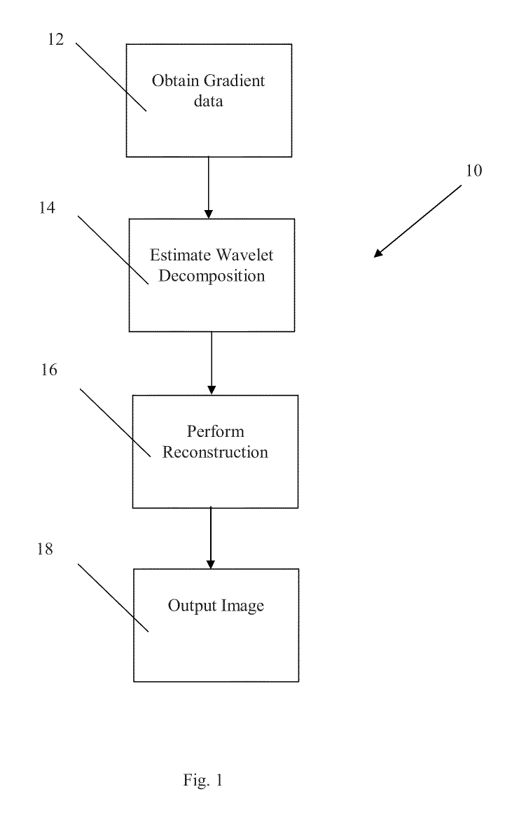

Referring to FIG. 1, a method for reconstructing a digital image 10 is generally shown. At step 12, gradient data of a visual scene is obtained. At step 14, a wavelet decomposition operation is performed on the gradient data. Following wavelet decomposition, a reconstruction operation including analysis and synthesis steps is performed, as indicated at step 16. At step 18, a reconstructed digital image is outputted. The method may be implemented in any image-generating device including an image-displaying device, such as a view finder, for example, an image-capturing device such as a gradient camera, for example, or an image-replicating device such as a digital copier, for example. The reconstructed digital image may be output to an image file and may be stored in any image-storing device such as a hard disk drive, for example.

Referring also to FIG. 1a, the gradient data is calculated using pixel data of a visual scene that has been captured using an image sensing device 50. The image sensing device 50 may be a gradient sensor or any suitable image sensing device. A computer processor 52 executes a gradient data calculation process 54, a wavelet decomposition process 56 and an image reconstruction process 58 before outputting an image to an image output device 58. Software for performing each of the computer processes 54, 56 and 58 is stored on a computer-readable medium that is in communication with the processor 52. The processes 54, 56, 58 are performed in the order described with output from the gradient data calculation process 54 being used as input for the wavelet decomposition process 56 and output from the wavelet decomposition process 56 being used as input to the image reconstruction process 58.

The method of FIG. 1 determines an estimate of the wavelet decomposition from the gradient measurements rather than building an image estimate directly using pixel intensities. Gradient data of a visual scene is obtained by computing the difference between intensities of neighboring pixels. Alternatively, a sensor capable of directly measuring the difference in light power between two neighboring points may be used.

The method of FIG. 1 is not limited to visual images. For example, the gradient of electromagnetic wave-fronts can be measured using a wave-front sensor (WFS), such as a Shack-Hartmann WFS(SH-WFS), for example. The WFS measures the gradient of the incoming wave-front at discrete points of a 2-D array, rather than the wave-front shape itself.

In one embodiment, the type of wavelet decomposition is Haar wavelet decomposition and the type of synthesis is Haar synthesis. The Haar wavelet decomposition is an alternate representation of all of the information in an image. Although not a visually useful representation, the Haar decomposition is useful because it is only a few known mathematical operations from an image.

In the embodiment of FIG. 1, the filterbanks required for the decomposition are derived directly from the 2-D Haar Wavelet Analysis Filterbank (HWAF) so that the gradient data can be used as input to the filterbank instead of the image pixel data. The original image can then be obtained from this decomposition using a 2-D Haar Wavelet Synthesis Filterbank (HWSF).

The use of the wavelet decomposition leads to several benefits with respect to computation complexity, reconstruction accuracy and capability to deal with input measurement noise. The computational complexity of the proposed reconstruction method is of O(N) which is a consequence of using a modification of the Discrete Wavelet Transform (DWT). This solution holds for any scale of data, which is advantageous because many image producing devices include a large number of sensor measurements such as cameras, for example.

The DWT has further the property to ‘concentrate’ most of the energy of the signal in a ‘small’ number of coefficients and thus allow for de-noising of the signal using the wavelet coefficients. In the method of FIG. 1, wavelet coefficients of the wavelet decomposition can be used to alleviate the effects of any measurement noise in the input. In fact, for signals such as the wave-fronts with aberrations due to atmospheric turbulence which do not contain high frequencies, the high frequency part (HH) of the wavelet decomposition can be ignored and thus combine de-noising with reduced computations.

Details of the Haar filter definition will now be described.

Decompositions of data may be obtained by filtering in either the vertical or horizontal directions. To distinguish between these directions, zₕ will indicate horizontal filtering of rows whereas zᵥ will indicate vertical filtering of columns. The orthogonal Haar filters are as follows:

H_{L}(z)=(1+z⁻¹)/\sqrt{2} (1)

H_{H}(z)=(1−z⁻¹)/\sqrt{2} (2)

Details of the gradient sensing examples of the method of FIG. 1 will now be described.

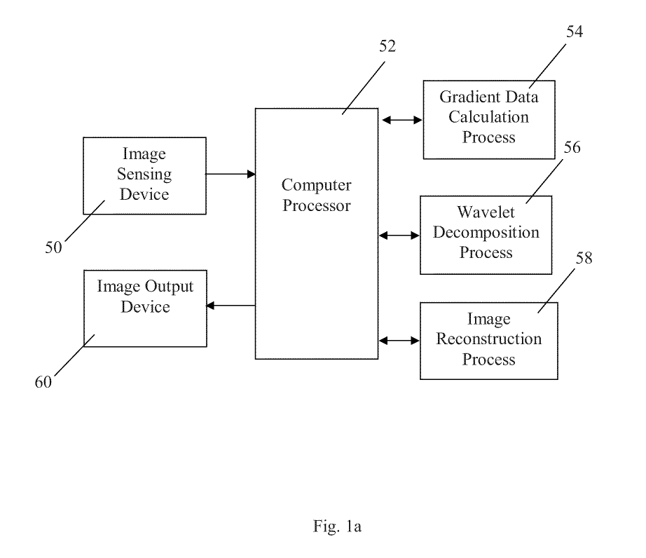

In Adaptive Optics (AO), two different geometries have been used to represent the gradient data. The Hudgin geometry and the Fried geometry. Using the Hudgin geometry in FIG. 2, the difference between two points is sensed and the gradient data is:

_{H}\tilde{x}_{i,j}=−φ_{i,j}φ_{i,j+1} (3)

_{H}\tilde{y}_{i,j}=−φ_{i,j}φ_{i+1, j} (4)

It will be appreciated that square data sets are operated on in the image reconstruction method. The value of 2^{M} is the width of the square image in number of pixels. Rectangular data sets are processed by a reflection based method of extrapolation.

Thus, the horizontal and vertical gradients of an image MΦ of size 2^{M}2^{M}, using the Hudgin geometry can be represented as matrices _{H}^{M}\tilde{X} and _{H}^{M}\tilde{Y} respectively and will be of size 2^{M}×(2^{M}−1) and (2^{M}−1)×2^{M}, respectively. This non-square structure is the result of filtering ^{M}Φ, in only one direction for each of the gradient directions

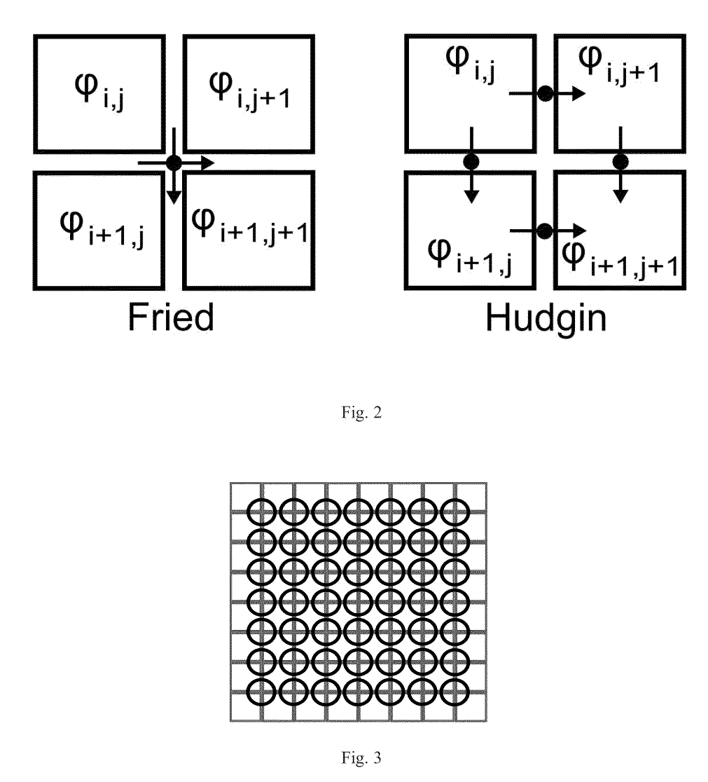

Fried and Hudgin geometries are shown in FIG. 2. Using the Fried geometry, the sensor measurement is made in the center of a square of four grid points. This is shown in FIG. 3 in which the sensor locations are depicted as circles and the pixels are depicted as squares. This can be the average of two adjacent Hudgin aligned sensors or direct measurement of Fried aligned sensors. The Fried geometry is represented by the following two equations for each individual sensor:

$$\begin{matrix}\begin{matrix}{}_{F}^{}{\tilde{x}}{}_{i , j}^{} = 0.5 ( {}_{H}^{}{\tilde{x}}{}_{i , j}^{} + {}_{H}^{}{\tilde{x}}{}_{i + 1 , j}^{} ) \\ = 0.5 ( - {ϕ}_{i , j} + {ϕ}_{i , j + 1} - {ϕ}_{i + 1 , j} + {ϕ}_{i + 1 , j + 1} )\end{matrix} & ( 5 ) \\ \begin{matrix}{}_{F}^{}{\tilde{y}}{}_{i , j}^{} = 0.5 ( {}_{H}^{}{\tilde{y}}{}_{i , j}^{} + {}_{H}^{}{\tilde{y}}{}_{i , j + 1}^{} ) \\ = 0.5 ( - {ϕ}_{i , j} - {ϕ}_{i , j + 1} + {ϕ}_{i + 1 , j} + {ϕ}_{i + 1 , j + 1} )\end{matrix} & ( 6 )\end{matrix}$$

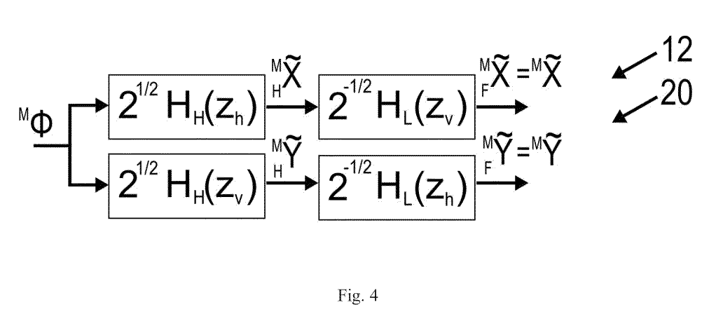

The horizontal and vertical gradients of an image ^{M}φ, using the Fried geometry, can then be represented as matrices _{F}^{M}\tilde{X} and _{F}^{M}\tilde{Y} respectively and will be of size (2^{M}−1)×(2^{M}−1). The relationship between the gradient measurements obtained using these two geometries can be represented by the Haar filters and are shown in FIG. 4 and in the following equations:

$$\begin{matrix}{}^{M} \tilde{X} = {}_{F}^{M} \tilde{X} = \frac{{}_{H}^{M} \tilde{X} {H}_{L} ( {z}_{v} )}{\sqrt{2}} = {}^{M} Φ {H}_{H} ( {z}_{h} ) {H}_{L} ( {z}_{v} ) & ( 7 ) \\ {}^{M} \tilde{Y} = {}_{F}^{M} \tilde{Y} = \frac{{}_{H}^{M} \tilde{Y} {H}_{L} ( {z}_{h} )}{\sqrt{2}} = {}^{M} Φ {H}_{L} ( {z}_{h} ) {H}_{H} ( {z}_{v} ) & ( 8 )\end{matrix}$$

The previously described measurement methods are two examples of many different approaches to obtain gradient data. It will be appreciated by a person skilled in the art that any method of obtaining gradient data may be used. Once the gradient data has been obtained it is reformatted via filtering to the Fried alignment.

For example, the method of FIG. 1 is further operable on an alternate model of the Fried aligned gradient sensor. The alternate model takes a 4×4 block of phase screen pixels and determines the average slope in the horizontal and vertical directions. Due to mathematical canceling from numerical integration of the difference of pixels, our interpretation of the sensor is as follows:

$$\begin{matrix}{x}_{p , q} = \frac{1}{3} {\sum }_{i} {\sum }_{k} [ \begin{matrix}- {φ}_{i , k} & 0 & 0 & {φ}_{i , k + 3} \\ - {φ}_{i + 1 , k} & 0 & 0 & {φ}_{i + 1 , k + 3} \\ - {φ}_{i + 2 , k} & 0 & 0 & {φ}_{i + 2 , k + 3} \\ - {φ}_{i + 3 , k} & 0 & 0 & {φ}_{i + 3 , k + 3}\end{matrix} ] & ( 9 ) \\ {y}_{p , q} = \frac{1}{3} {\sum }_{i} {\sum }_{k} [ \begin{matrix}- {φ}_{i , k} & - {φ}_{i , k + 1} & - {φ}_{i , k + 2} & - {φ}_{i , k + 3} \\ 0 & 0 & 0 & 0 \\ 0 & 0 & 0 & 0 \\ {φ}_{i + 3 , k} & {φ}_{i + 3 , k + 1} & {φ}_{i + 3 , k + 2} & {φ}_{i + 3 , k + 3}\end{matrix} ] & ( 10 )\end{matrix}$$

Where p and q are the row and column of the measurement point on the sensor grid and i=4p−1 and k=4q−1 are the row and column representing the top corner of the respective 4×4 cell of the phase screen. The indices i and k were chosen so that a 512×512 data set would generate 127×127 gradient sensor grid points to sense 128×128 pixels in Fried alignment.

The alternate model of the Fried aligned gradient sensor is different from the Fried model based on two factors: (i) the reduction in resolution from the data set to the measurement resolution, and (ii) Fried model for this resolution change would consist of 2 sets of 16×16 nonzero weighting factors and the alternate model uses a 4×4 area where half of the points are weighted by zero.

Details of the Haar wavelet decomposition and Haar synthesis steps of the method of FIG. 1 will now be described.

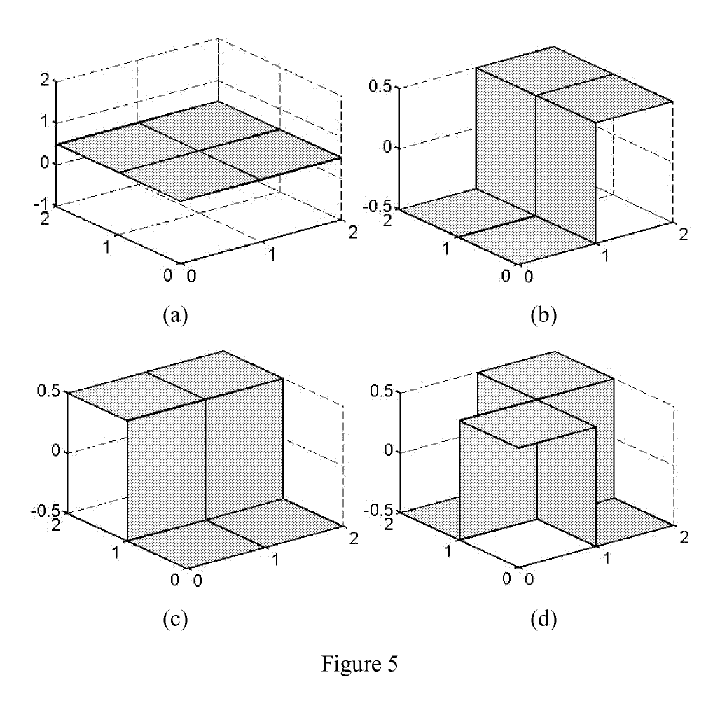

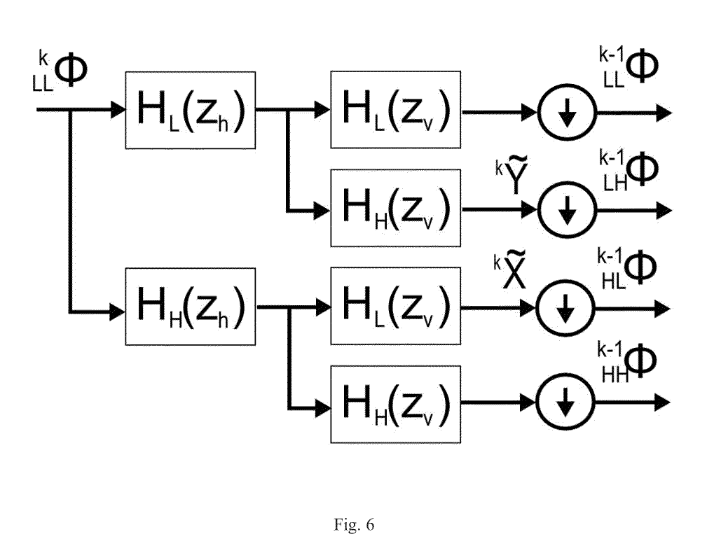

The 2-D Haar wavelets have 2×2 pixel support and are shown in FIG. 5. Two of the four wavelet shapes are 2-D discrete partial differentiation operators as shown in FIG. 5(b) and (c) as well as in (12) and (13). FIG. 5(a) shows a scaling function, FIG. 5(b) shows a horizontal discrete partial derivative operator, FIG. 5(c) shows a vertical discrete partial derivative operator and FIG. 5(d) shows a high frequency shape referred to as a waffle or checkerboard pattern.

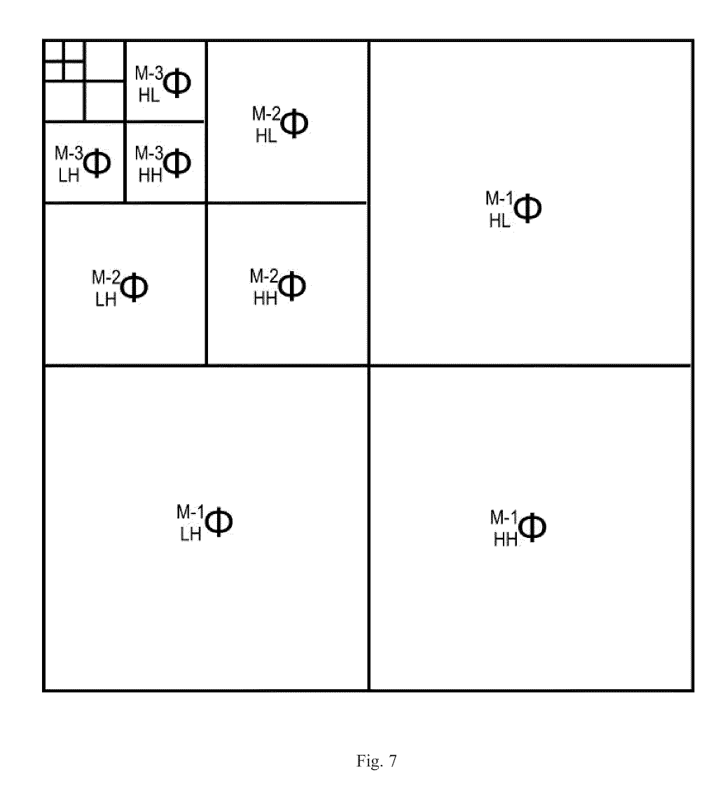

The structure of one stage of the 2-D Haar wavelet analysis filterbank (HWAF) is shown in FIG. 6. Stages cascade by connecting the LL output to the LL input of the next stage. The symbol φ represents a 2-D image. The superscript to the top left of ^{k}φ indicates the stage and also the size of the 2-D image, i.e. ^{k}φ is of size 2^{k}×2^{k} for k=1≦k≦M. The subscripts LL, LH, HL and HH introduced in FIG. 6 indicate the order that the Haar filters were applied to the signal.

It should be noted that the notations _{LL}^{M}Φ and ^{M}Φ are interchangeable.

By cascading wavelet filter blocks such as the one in FIG. 6 to each LL output, an M-stage 2-D filterbank is obtained where the output of the last stage is a block of 2×2 pixels. This M-stage HWAF leads to the decomposition of FIG. 7.

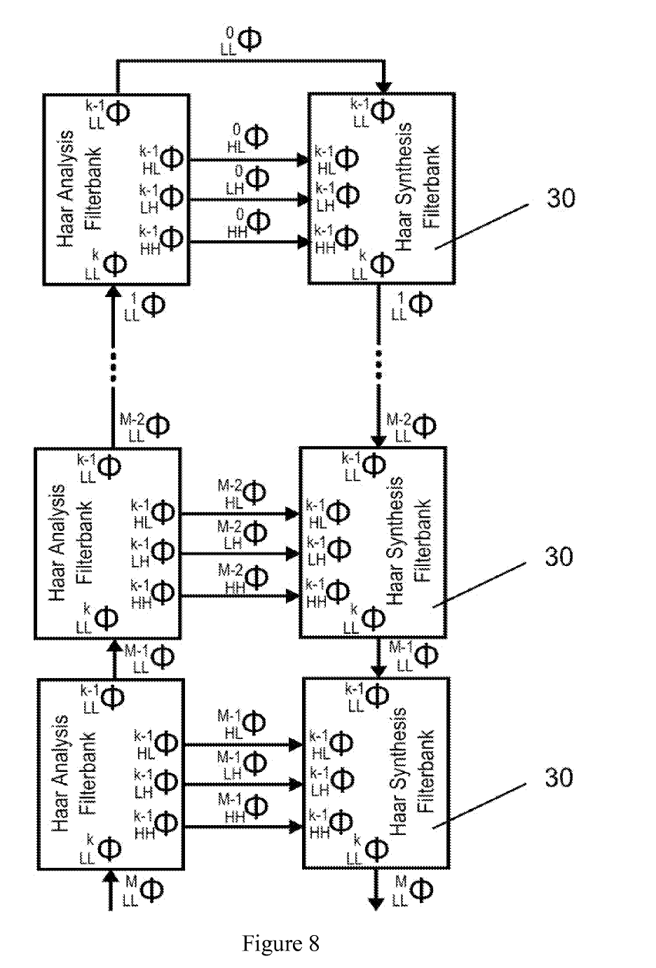

Shifts in the horizontal direction are denoted with subscript h and shifts in the vertical direction use subscript v. The magnitude of each of the four Haar wavelet shapes for resolutions that are less than the original image are determined by the recursive equations (11) to (13):

$$\begin{matrix}{}_{LL}^{k - 1} Φ = {↓}_{2} \{ {}_{LL}^{k} Φ \frac{( {z}_{h} + 1 ) ( {z}_{v} + 1 )}{2} \} & ( 11 ) \\ {}_{HL}^{k - 1} Φ = {↓}_{2} \{ {}_{LL}^{k} Φ \frac{( {z}_{h} - 1 ) ( {z}_{v} + 1 )}{2} \} & ( 12 ) \\ {}_{LH}^{k - 1} Φ = {↓}_{2} \{ {}_{LL}^{k} Φ \frac{( {z}_{h} + 1 ) ( {z}_{v} - 1 )}{2} \} & ( 13 ) \\ {}_{HH}^{k - 1} Φ = {↓}_{2} \{ {}_{LL}^{k} Φ \frac{( {z}_{h} - 1 ) ( {z}_{v} - 1 )}{2} \} & ( 14 )\end{matrix}$$

Where the size of the data of ^{k}φ is 2^{k}×2^{k} and similarly ^{k-1}φ is 2^{k-1}×2^{k-1} and is valid for positive integer values of k. The Haar wavelet decomposition is normally computed from an analysis filterbank that operates on the data set as in FIG. 8. This is followed by synthesis to obtain the data again. This is a lossless process unless the decomposed signals are altered via transmission error and lossy compression techniques. The Haar decomposition is often structured as in FIG. 7 in order to use the same amount of memory space as ^{M}φ.

Using the equivalent analysis filters for M-stage 2-D filterbanks, the non-recursive structure of the Haar wavelet decomposition of the image can be obtained as:

$$\begin{matrix}{}_{LL}^{M - m} Φ = {↓}_{{2}^{m}} \{ {}^{M} Φ {\prod }_{k = 0}^{m - 1} {H}_{L} ( {z}_{h}^{{2}^{i}} ) {\prod }_{k = 0}^{m - 1} {H}_{L} ( {z}_{v}^{{2}^{k}} ) \} & ( 15 ) \\ {}_{LH}^{M - m} Φ = {↓}_{{2}^{m}} \{ {}^{M} Φ {H}_{H} ( {z}_{v}^{{2}^{m - 1}} ) {\prod }_{k = 0}^{m - 1} {H}_{L} ( {z}_{h}^{{2}^{k}} ) {\prod }_{k = 0}^{m - 2} {H}_{L} ( {z}_{v}^{{2}^{k}} ) \} & ( 16 ) \\ {}_{HL}^{M - m} Φ = {↓}_{{2}^{m}} \{ {}^{M} Φ {H}_{h} ( {z}_{h}^{{2}^{m - 1}} ) {\prod }_{k = 0}^{m - 2} {H}_{L} ( {z}_{h}^{{2}^{k}} ) {\prod }_{k = 0}^{m - 1} {H}_{L} ( {z}_{v}^{{2}^{k}} ) \} & ( 17 ) \\ {}_{HH}^{M - m} Φ = {↓}_{{2}^{m}} \{ \begin{matrix}{}^{M} Φ {H}_{H} ( {z}_{h}^{{2}^{m - 1}} ) {H}_{H} ( {z}_{v}^{{2}^{m - 1}} ) … \\ … {\prod }_{k = 0}^{m - 2} {H}_{L} ( {z}_{h}^{{2}^{k}} ) {\prod }_{k = 0}^{m - 2} {H}_{L} ( {z}_{v}^{{2}^{k}} )\end{matrix} \} & ( 18 )\end{matrix}$$

Where ↓ₖ{ } is the down sampling function in both horizontal and vertical directions by the factor k. The first valid data point of filtering is where the data fully supported the filter. Down sampling by two retains data points on odd columns and rows.

The HWAF given by equations (11) to (14) or less efficiently by equations (15) to (18) provides a decomposition of the image. This is arranged according to FIG. 7. This decomposition was previously only found directly from the image.

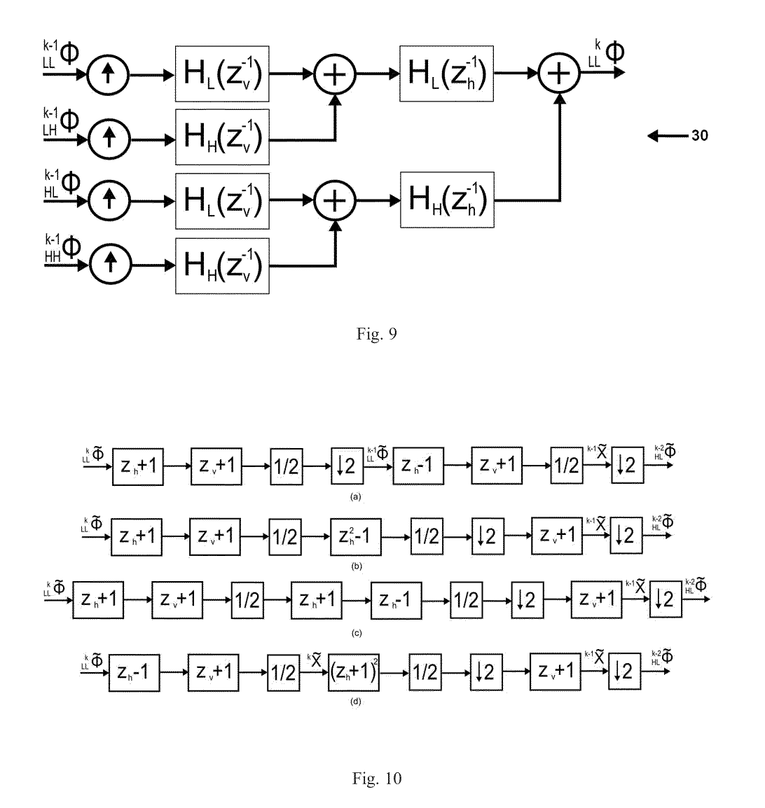

The original image can then be reconstructed by applying a standard HWSF to the image decomposition. With the structure shown in FIG. 9, the decomposition provided by the HWAF is perfectly reversible by the HWSF.

The Haar wavelet decomposition estimation using gradient measurements will now be described.

When the gradient sensor equals the Fried model, the signals _{HL}^{M-1}Φ and _{LH}^{M-1}Φ are the signals ↓₂{^{M}X} and ↓₂{^{M}Y}. In applications such as AO, for example, in which ^{M}X and ^{M}Y are given as measurements, half of the Haar decomposition is obtained by simple down sampling. Even if the remaining unknown half of the decomposition was determined via a pseudo-inverse that is O(N²), the solution speed is increased by a factor of 4.

_{HL}^{M-1}Φ=↓₂{^{M}X} (19)

_{LH}^{M-1}Φ=↓₂{^{M}Y} (20)

Alternatively, the Haar Analysis Filterbank can be rearranged through the use of the noble identities, factoring and re-ordering of these Linear Time Invariant filters to obtain the remainder of the Haar decomposition.

Referring to FIG. 10(a), the recursive structure of one branch of the Haar Analysis Filter to obtain the decomposition components based on low pass filtering and down sampling the data set, _{LL}^{k}Φ, is shown. Signal ^{k-1}X is generally unnamed in the standard Haar decomposition process but is included on this line for clarity of the derivation. FIG. 10(b) shows the result of moving the high pass filter from after the down-sampler to before the down-sampler. This causes the exponent of the z term to double according to the noble identity.

It will be appreciated by a person skilled in the art that movement of a filter from after the down-sampler to before the down-sampler is not the usual use of this identity in this structure since the filter implementation becomes less efficient in general.

FIG. 10(c) shows how this high pass filter can be factored into high pass and low pass filters.

Finally, the filters are ordered in FIG. 10(d) so that it is clear how ^{k}X can be obtained from _{LL}^{k}Φ and subsequently ^{k-1}X can be obtained from ^{k}X. Since ^{M}X is given as a measurement, all ^{k}X for kε[1,M−1] can be solved with no direct knowledge of _{LL}^{M}Φ.

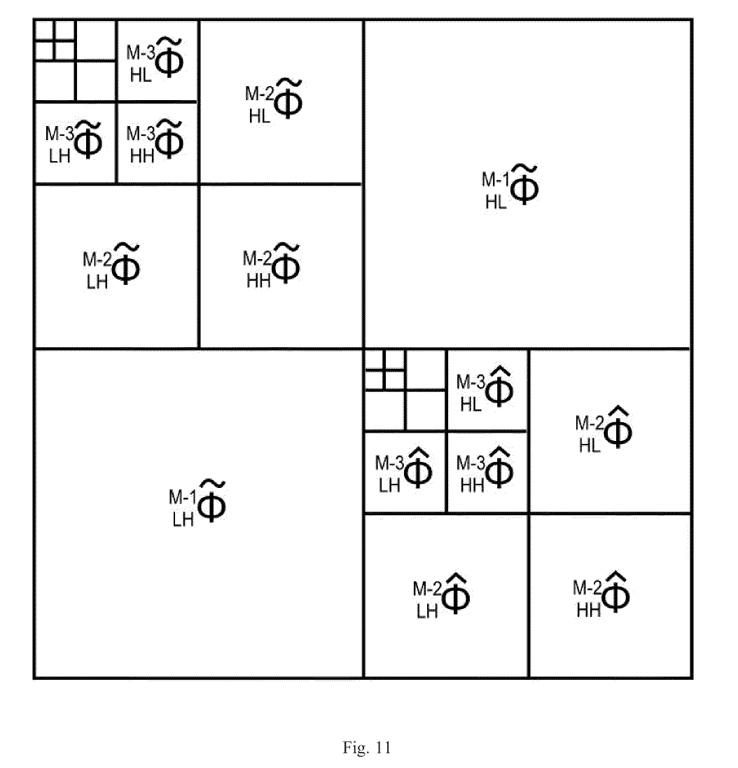

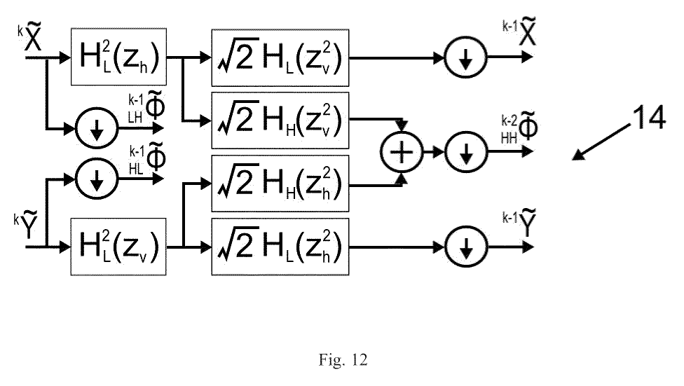

Haar decomposition from gradient data, which is shown in FIG. 11, is provided by generating the decomposition from ^{M}\tilde{X} and ^{M}\tilde{Y}, (7) and (8) and then obtaining the original wavefront using standard HWSFs applied to the decomposition. The decomposition of FIG. 11 was developed based on the similarity between the Haar wavelet and the representation of the gradient measurements using the Fried model. Comparing FIG. 4 to FIG. 6 it is clear that gradient data that matches the Fried model perfectly provides the filtering necessary to obtain _{LH}^{M-1}φ and _{HL}^{M-1}φ. All that is required is down sampling of the measurements to obtain the upper-right and lower-left part of the decomposition shown in FIG. 6. Obtaining the diagonal sections of FIG. 11 using the gradient data requires the development of filterbanks which are no more than a manipulation of the order of operations of the linear filters in the HWAF and the HWSF.

The algebraic proof is provided in Appendix I.

This manipulation can be considered as converting the Haar decomposition from a de-noising/compression tool into an intermediate step when solving 2-D discrete partial differential equations.

The reconstruction of the original wave-front is obtained in two steps: analysis and synthesis steps. An example of an application of the analysis and synthesis steps is provided in an algorithm, which is outlined below. The filterbank for the first three quadrants of FIG. 11 is given as FIG. 12.

Analysis Step: Given ^{M}\tilde{X} and ^{M}\tilde{Y}, in (7) and (8), generate the decomposition of FIG. 11:

HL and LH quadrants (upper right and lower left quadrants):

_{HL}^{M-1}\tilde{φ}=↓₂{^{M}φH_{H}(zₕ)H_{L}(zᵥ)}↓₂{^{M}\tilde{X}} (21)

_{LH}^{M-1}\tilde{φ}=↓₂{^{M}φH_{L}(zₕ)H_{H}(zᵥ)}↓₂{^{M}\tilde{Y}} (22)

LL quadrant (upper left quadrant of FIG. 11):

$$\begin{matrix}For k = M to 2 & \\ {}^{k - 1} \tilde{Y} = \sqrt{2} {↓}_{2} \{ {}^{k} \tilde{Y} {H}_{L} ( {z}_{h}^{2} ) {H}_{L}^{2} ( {z}_{v} ) \} & ( 23 ) \\ {}^{k - 1} \tilde{X} = \sqrt{2} {↓}_{2} \{ {}^{k} \tilde{X} {H}_{L}^{2} ( {z}_{h} ) {H}_{L} ( {z}_{v}^{2} ) \} & ( 24 ) \\ {}_{LH}^{k - 2} \tilde{Φ} = {↓}_{2} \{ {}^{k - 1} \tilde{Y} \} & ( 25 ) \\ {}_{HL}^{k - 2} \tilde{Φ} = {↓}_{2} \{ {}^{k - 1} \tilde{X} \} & ( 26 ) \\ \begin{matrix}{}_{HH}^{k - 2} \tilde{Φ} = \sqrt{2} {↓}_{4} \{ {}^{k} \tilde{Y} {H}_{H} ( {z}_{h}^{2} ) {H}_{L}^{2} ( {z}_{v} ) \} \\ = \sqrt{2} {↓}_{4} \{ {}^{k} \tilde{X} {H}_{L}^{2} ( {z}_{h} ) {H}_{H} ( {z}_{v}^{2} ) \}\end{matrix} & ( 27 ) \\ end & \\ {}_{LL}^{0} \tilde{Φ} = {2}^{m} mean ( Φ ) & ( 28 )\end{matrix}$$

i.e. _{LL}⁰\tilde{φ} is proportional to the mean value of the image.

HH quadrant (lower right quadrant of FIG. 11):

$$\begin{matrix}For k = M to 2 & \\ {}^{k - 1} \hat{X} = \{ \begin{matrix}\sqrt{2} {↓}_{2} \{ {}^{M} \tilde{X} {H}_{L} ( {z}_{h}^{2} ) {H}_{H}^{2} ( {z}_{v} ) \} & for K = M \\ \sqrt{2} {↓}_{2} \{ {}^{k} \tilde{X} {H}_{L} ( {z}_{h}^{2} ) {H}_{L}^{2} ( {z}_{v} ) \} & for K < M\end{matrix} & ( 29 ) \\ {}^{k - 1} \hat{Y} = \{ \begin{matrix}\sqrt{2} {↓}_{2} \{ {}^{M} \tilde{Y} {H}_{H}^{2} ( {z}_{h} ) {H}_{L} ( {z}_{v}^{2} ) \} & for K = M \\ \sqrt{2} {↓}_{2} \{ {}^{k} \tilde{Y} {H}_{L}^{2} ( {z}_{v} ) {H}_{L} ( {z}_{v}^{2} ) \} & for K < M\end{matrix} & ( 30 ) \\ {}_{LH}^{k - 2} \hat{Φ} = {↓}_{2} \{ {}^{k - 1} \tilde{X} \} & ( 31 ) \\ {}_{HL}^{k - 2} \hat{Φ} = {↓}_{2} \{ {}^{k - 1} \tilde{Y} \} & ( 32 ) \\ \begin{matrix}{}_{HH}^{k - 2} \hat{Φ} = \{ \begin{matrix}\sqrt{2} {↓}_{4} \{ {}^{M} \tilde{Y} {H}_{H}^{2} ( {z}_{h} ) {H}_{H} ( {z}_{v}^{2} ) \} \\ \sqrt{2} {↓}_{4} \{ {}^{k} \hat{Y} {H}_{L}^{2} ( {z}_{h} ) {H}_{H} ( {z}_{v}^{2} ) \}\end{matrix} for \begin{matrix}K = M \\ K < M\end{matrix} \\ = \{ \begin{matrix}\sqrt{2} {↓}_{4} \{ {}^{M} \tilde{X} {H}_{H} ( {z}_{h}^{2} ) {H}_{H}^{2} ( {z}_{v} ) \} \\ \sqrt{2} {↓}_{4} \{ {}^{k} \hat{X} {H}_{L} ( {z}_{h}^{2} ) {H}_{L}^{2} ( {z}_{v} ) \}\end{matrix} for \begin{matrix}K = M \\ K < M\end{matrix}\end{matrix} & ( 33 ) \\ end & \end{matrix}$$

Synthesis Step: Given the image decomposition of FIG. 11 obtained in the Analysis step: Apply an M−1-stage HWSF to HH quadrant to obtain _{HH}^{M-1}\hat{φ}. Apply an M-stage HWSF to all 4 quadrants, including _{HH}^{M-1}\hat{φ}, to obtain the wave-front estimate.

The above equations have been obtained by combining (7) or (8) with (16) through (18) to obtain the wavelet decomposition given in FIG. 11 from the gradient signals ^{M}\tilde{X} and ^{M}\tilde{Y}, instead of the image, ^{M}Φ, as input (see Appendix I).

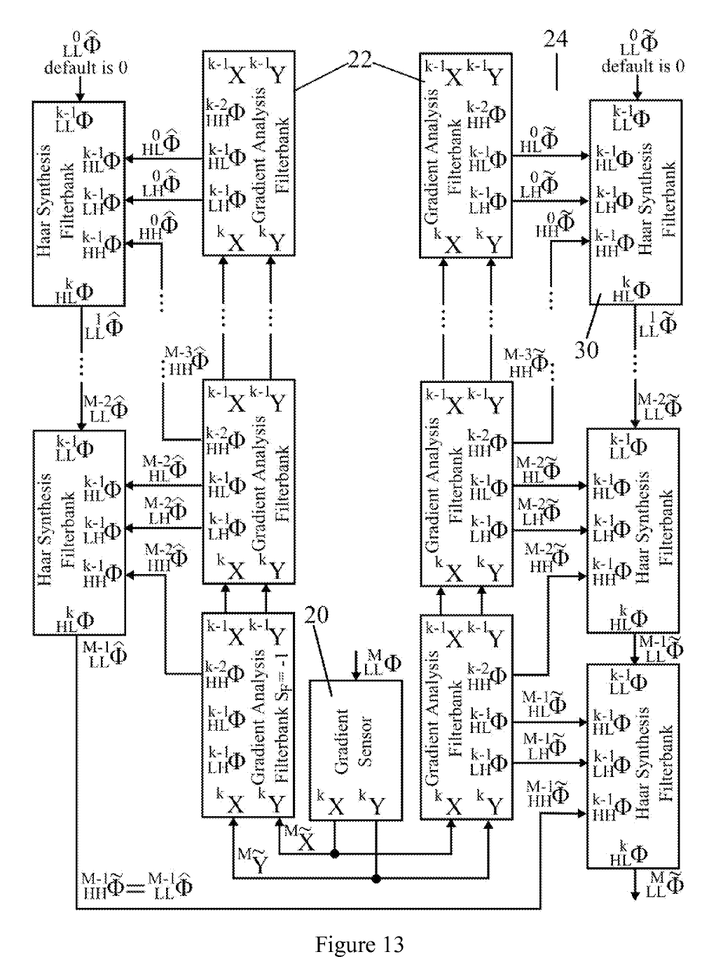

FIG. 13 provides a layout of the method to convert a gradient measurement into the original signal as an alternate representation than has been previously described. The left branch of the analysis generates an estimate of _{HH}^{M-1}Φ for use in the final synthesis step.

The analysis filterbank allows the low frequency analysis filterbank structure to be reused for the high frequency region by swapping the input labels and setting s_{F} to −1, as shown. For example, ^{M}\tilde{X} is connected to kY on the analysis filter marked sF=−1.

There are two entries in the decomposition given in FIG. 11 which can not be obtained from the gradient data. The first is _{LL}⁰\tilde{φ} which is the mean of the image and could be found with an additional sensor to measure the mean. In AO, the mean is called piston and it may be acceptable that this value would be set to 0. In other applications, _{LL}⁰\tilde{Φ} can be estimated from the knowledge of the signal dynamic range, i.e. assuming the lowest value is 0 and/or maximum is 255 for 8-bit representations.

Color view finders can be determined without direct measurement of the individual mean values of each color. The assumptions are (i) black exists in the picture, (ii) all colors are scaled equally to allow pixels to have the maximum value of the dynamic range and (iii) in the event of coarse sampling of the gradient for view finders, the constant slope of each color is set to zero to avoid obvious distortions.

Removal of the constant slope is not necessary for reconstructions from full resolution data.

It will be appreciated by a person skilled in the art that additional sensors may be provided to resolve the average intensity of each color and/or the constant slope of the change of color across the aperture.

The other entry is _{LL}⁰\hat{φ}. The HH quadrant represented by _{HH}^{M-1}φ in FIG. 5 is entirely composed of 2×2 waffle, just as _{LH}^{M-1}φ and _{HL}^{M-1}φ are 2×2 tilts and _{LL}^{M-1}φ is 2×2 pistons. Any waffle-type shape is composed of linear combinations of these 2×2 waffle modes. However, _{HH}^{M-1}φ can not be solved directly because it contains one invisible waffle shape. This mode is proportional to a checkerboard pattern given as (−1)'^{i+j}, where i and j represent the row and column of the image. It was determined that the invisible component of _{HH}^{M-1}φ can be isolated by applying an M−1 stage HWAF to _{HH}^{M-1}φ. This allows the other visible components to be solved directly. The magnitude of invisible waffle is directly proportional to _{LL}⁰\hat{φ}. As suggested by the subscripts, it is directly proportional to the mean value of all the 2×2 waffle modes that compose _{HH}^{M-1}φ. Such a high frequency component is known to be unusable in AO and is also expected to not have a significant magnitude in digital photography. This is supported by the small reconstruction error found in later examples. Therefore, _{LL}⁰\hat{φ} can be set to 0 and ignored without significant error.

It will be appreciated by a person skilled in the art that calculation of all components of the decomposition is not necessary. The _{HH}^{M-1}Φ region is the highest frequency region. The resulting image benefits from indirect filtering when regions of the decomposition are ignored. Also, the computation cost reduces because the respective region was not calculated.

It is known from atmospheric turbulence models that the high spatial frequency shapes are reduce by a factor of f^{11/3} in power as spatial frequency increases, which makes the signal to noise ratio (SNR) poor at high frequencies. It can be desirable to remove the localized waffle from the corrected modes. The Haar decomposition automatically isolates compactly supported waffle modes into the HH quadrant. This allows for removal of these modes simply by not computing the respective portion of the decomposition.

The analysis and synthesis steps have been developed using a square grid of gradient measurements. Rectangular data sets are more common in digital photography. These can be processed by extending the rectangular data sets by treating the picture edge as a simulated mirror. This is implemented as data copies in reverse order from the edge of the data. The horizontal gradients are also multiplied by negative one as they are reflected across a vertical mirror and vice versa.

In most astronomical AO systems, the gradients are available on a circular grid, not on a rectangular grid. Extending circular aperture measurements to rectangular measurements by zero padding leads to errors. Instead the extension has to be carried out in a way that takes care of the boundary. By using the discrete partial differentiation model, the extrapolation can be performed by choosing the exterior values such that curl is the integral of gradient measurements on any closed path must be zero in the absence of noise. The solution varies depending on the assumptions made of the exterior region. Assumptions shown in the art are to assume the field goes to zero after a transition period. The filterbank, which has been previously described, could also operate on these extended data sets.

Operation of the method for reconstructing a digital image will now be described by way of the following examples.

In one example, to evaluate the performance of the analysis and synthesis steps for wave-front reconstruction, atmospheric phase screens are generated using a Kolmogorov turbulence model with r₀ of 0.25 m, wave length of 500 nm, pupil diameter of 32 m and outer scale of 22 m. The phase screen generation software was developed according to the discussion in T. Nakajima, “Signal-to-noise ratio of the bispectral analysis of speckle interferometry,” J. Opt. Soc. Am. A. vol 5, 1477-(1988), which is herein incorporated by reference. The gradient data (^{M}\tilde{X} and ^{M}\tilde{Y}) are obtained by using a simulated sensor that uses the Fried aligned operators of equations (5) and (6), which have been previously described. The phase screen is 128×128 so that the Fried sensor model will provide two 127×127 sets of data.

The phase screen is reconstructed using the analysis and synthesis based on the simulated sensor data being contaminated, where appropriate, with Gaussian white noise. The input SNR is obtained using ^{M}\tilde{X} and ^{M}\tilde{Y} as the signal similarly to the disclosure of the Vogel et al. reference. To evaluate the capacity of the analysis and synthesis steps to remove high frequency waffle, two reconstructions are produced for each test. The first is based on using the full decomposition of FIG. 7 while in the second the HH quadrant is suppressed (i.e. equating all entries of _{HH}^{M-1}\hat{Φ} to zero). The quality of the reconstruction is evaluated using the root mean square (rms) normalized residual error of the pixels of a single phase screen calculated by:

$${E}_{R} = \frac{‖ {Φ}_{Reconstructed} - {Φ}_{original} ‖}{‖ {Φ}_{original} ‖} \qquad ( 34 )$$

as well as the 66 Zernike modes (corresponding up to radial order 10) of a largest inner circle inside the 128×128 phase screen.

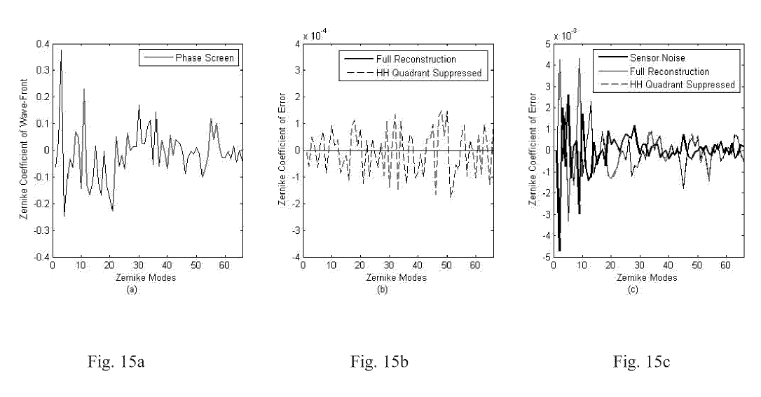

In the first part of this example, the phase screen was reconstructed assuming no measurement noise. The full wave-front reconstruction using the analysis and synthesis steps is shown in FIG. 15(a). There is no visible difference between the full reconstruction and the reconstruction with neglected HH. This indicates speed improvements with negligible loss of visual quality. The error for the full reconstruction is shown in FIG. 15(c) and is only composed of a pure checkerboard pattern corresponding to the _{LL}⁰\hat{Φ} entry in the decomposition of FIG. 11. This entry is invisible to the sensor and the analysis and synthesis steps do not attempt to reconstruct this shape, just as it does not reconstruct the mean value. E_{R} for the full reconstruction is 0.000503 rms where the amplitude of the phase screen is normalized to 1 rms.

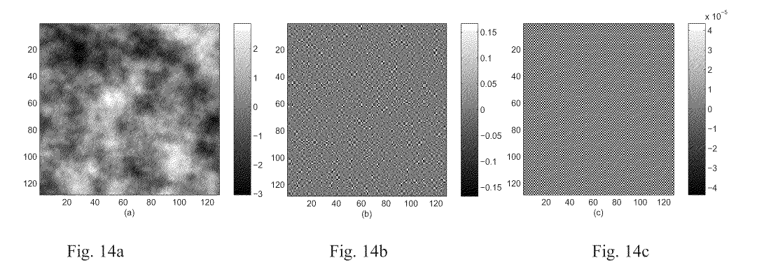

The error for the reconstruction neglecting HH is given in FIG. 14(b) and the corresponding E_{R} is 0.0383 rms. The Zernike coefficients for the original phase screen are shown in FIG. 15(a) and the Zernike coefficients of the reconstruction error for the two reconstructions are shown in FIG. 15(b). The low reconstruction error and the low relative magnitude of the Zernike coefficients of the reconstruction error indicate excellent reconstruction. Further, when there is no measurement noise the full reconstruction gives better results.

In the second part of this experiment, Gaussian white measurement noise with SNR=20 (i.e. 26 dB) is added to the gradient data and the phase screen is reconstructed from the noisy gradient data. The E_{R} for the full reconstruction is 0.0232 rms and the reconstruction neglecting HH is 0.0495 rms. Further, the Zernike coefficients of the reconstruction error for the full reconstruction and the reconstruction neglecting HH are shown in FIG. 15(c). For comparison, the Zernike coefficients of the reconstruction error obtained from directly projecting the gradient data to Zernike modes are shown as the dark line. For the 66 modes shown, the rms of the Zernike coefficients of the reconstruction error is only ˜1.5 times larger than the rms of the Zernike coefficients of the measurement noise.

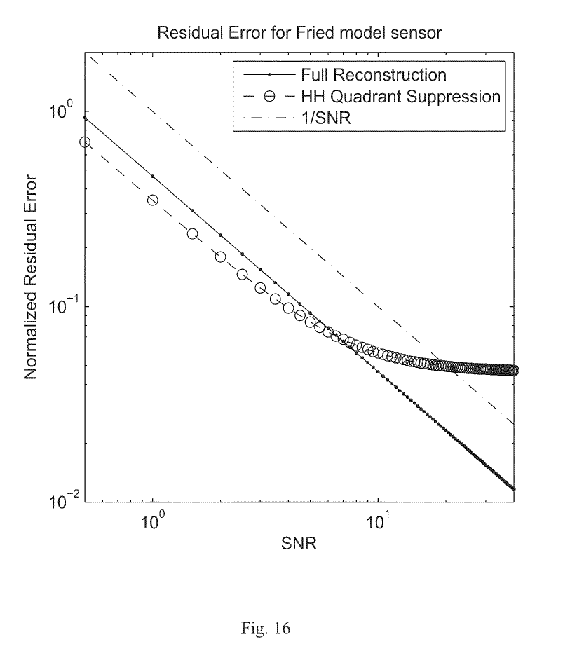

To further evaluate the performance of the proposed analysis and synthesis steps in the presence of measurement noise, a series of reconstructions using noisy gradient data with several values of SNR were performed for both the full reconstruction and the reconstruction neglecting HH. The results with respect to the normalized residual error are presented in FIG. 16.

It will be appreciated by a person skilled in the art that for AO examples, _{LL}⁰\tilde{φ} has been assumed to be zero. The assumption of _{LL}⁰\tilde{φ} equal to zero is accurate since the simulated wave-front has a mean of zero. In AO, the mean does not contribute to the error of wave-front correction so its actual value is irrelevant.

In another example, a 2048×2048 image is being considered and the Hudgin aligned gradient data, ^{M}\tilde{X}_{H} and ^{M}\tilde{Y}_{H}, are obtained using equations (3) and (4). The Hudgin model measures the difference between two neighbor pixels in the horizontal and vertical directions.

The method of reconstructing an image can solve for the original data by first converting this data to Fried aligned data as in equations (7) and (8).

Atmospheric turbulence, as described in the previous example, follows a known statistical model. In general, photographs do not. This example shows the performance of the method of FIG. 1 when solving discrete partial differential equations for unknown statistics of the data. The image is reconstructed from noiseless gradient data and the full reconstruction of the 8-bit image is substantially perfect after rounding to integer values.

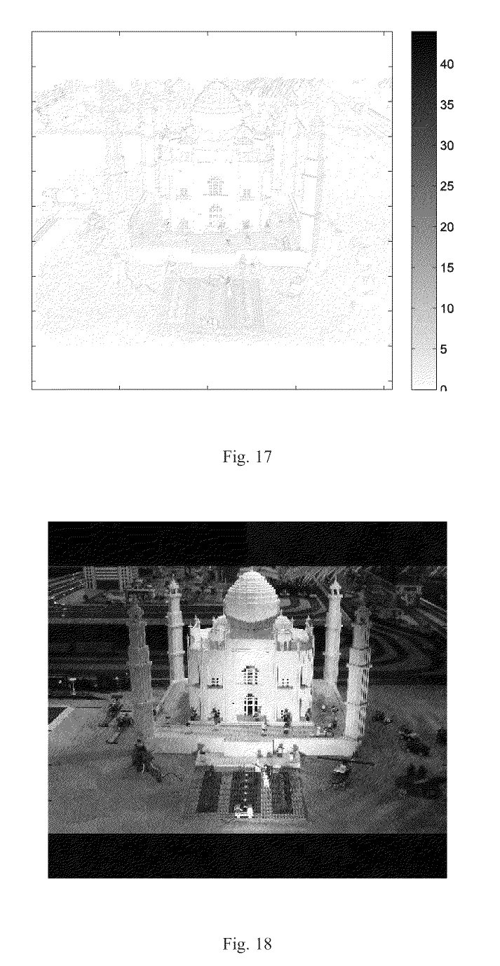

FIG. 17 shows the error when the data from the HH quadrant, i.e. _{HH}^{M-1}\tilde{Φ}, is not computed. The dynamic range of this error is about 88 (compared to 255 dynamic range of image). However, the rms of the reconstruction error when ignoring the HH quadrant is only −31 dB (0.028 rms).

In order to illustrate the effect of noise, the reconstruction of the above image is carried out using noisy gradient data. In FIG. 18, the reconstructed image using the method of FIG. 1 is shown for the case when the SNR of the noisy gradient data is 6 dB (i.e. SNR=2). The reconstruction error in FIG. 18 is −20.3 dB (0.095 rms). This is a visually acceptable reconstruction despite significant input noise.

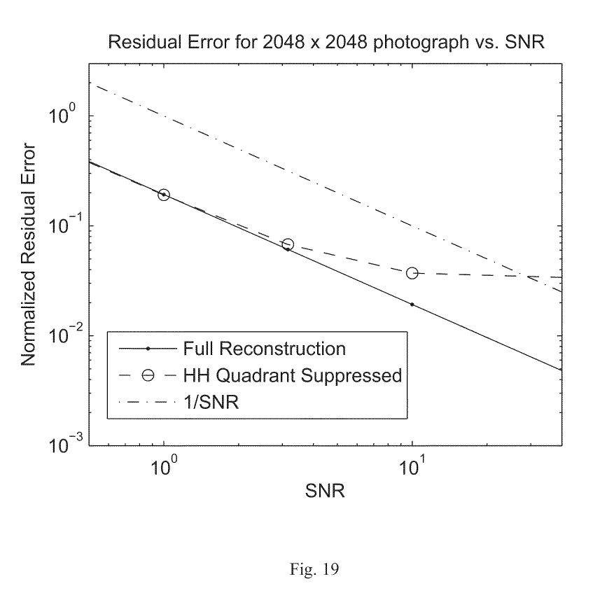

Measurement noise does have a significant effect on the quality of the estimate of data in the HH quadrant. FIG. 19 shows the SNR of the gradient data used as input and the SNR of the reconstruction error for both cases: full reconstruction and reconstruction while neglecting the HH quadrant. The full reconstruction error is shown to be −14.3 dB smaller than the inverse of the SNR. This means that the ratio of the reconstructed image to the reconstructed error is 5.2 times greater than the input signal to noise ratio. This result is independent of any de-noising techniques that could be applied.

It can be seen from FIG. 19 that when the input SNR is reduced to less than three, the _{HH}^{M-1}\hat{Φ} estimate becomes corrupted and the full reconstruction does not give lower reconstruction error than the reconstruction neglecting the HH quadrant.

In this example, the mean value is assumed not known and was set to zero for reconstruction. The reconstruction has a dynamic range of −75.959 to 179.041. Since the original image is an 8-bit image and coincidentally used the full 0 to 255 dynamic range, this implies that the mean should be chosen to be 75.959. However, the reported error ignores mean value error.

The previously described examples indicate that the method of FIG. 1 is a fast and efficient method to reconstruct simulated wave-fronts and/or images from gradient data when the application model matches the Hudgin or Fried models. By applying the method to photographs and to atmospheric turbulence models, it shows that the reconstruction is not dependant on assumed statistical properties of the data. For the 128×128 case, the full reconstruction improved the SNR by a factor of approximately 2 as opposed to approximately 5 for the 2048×2048 case. This suggests that noise rejection may improve as the data sets get larger and may help mitigate the effect of dividing the number of collected photons between more sensor points.

An important consideration is to determine how well the algorithm performs when the model does not match the sensor. The Fried model is only an approximation to how a real SH-WFS would operate. Naturally, reconstruction errors are introduced when the Fried sensor model does not match the SH-WFS and there are other forms of WFSs.

In one embodiment, gradient measurements are generated by equations (9) and (10) for a 127×127 sensor grid. This embodiment includes weighting from only eight pixels for each direction and thus this model only uses 12.5% of the area of support of the Fried model. The gradient data generated by Fried and Hudgin were calculated for the same phase screen and it was determined that the difference between the two data sets was 0.416 rms, normalized to the ideal Fried measurements. This modeling error is similar to SNR=2.4, though it is dependent on the phase screen itself and is not a random signal. Even with these large modeling errors that are not independent of the signal, the full reconstruction generated using the proposed algorithm had 0.136 rms reconstruction error. The reconstruction neglecting the HH component, resulted in a reduced error of 0.081 rms. For comparison, these relative errors are consistent with the results shown in FIG. 10 for a SNR value of about 3.

In another embodiment, in order to improve the reconstruction using the analysis and synthesis steps in the case of model mismatch, a simple low pass filter is applied to the gradient data using the alternate model. This low pass filtering reduced the difference between the gradient data form the alternate model and the Fried model to 0.227 rms (from 0.416 rms in the previous experiment). Using the filtered data, the full reconstruction resulted in an error of 0.055 rms and the reconstruction neglecting HH in a error of 0.060 rms. For comparison, using the Multigrid Conjugate-Gradient method (MGCG), which is an iterative method, the reconstruction error was improved from 0.20 rms to less than 0.01 rms by using curvature regularization.

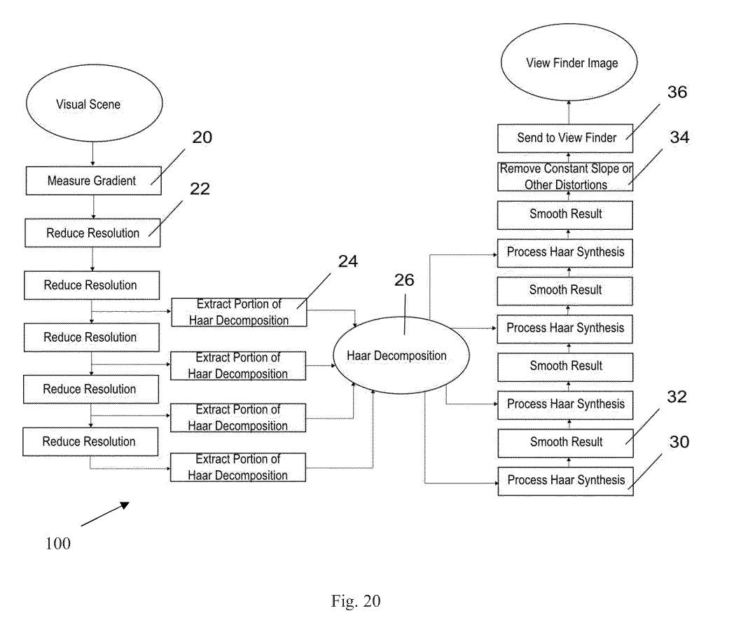

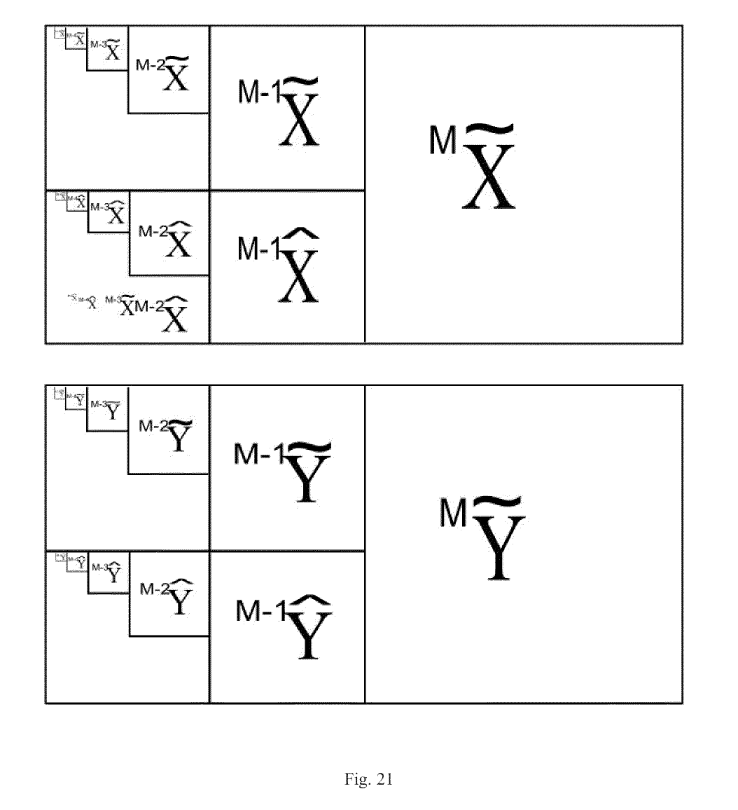

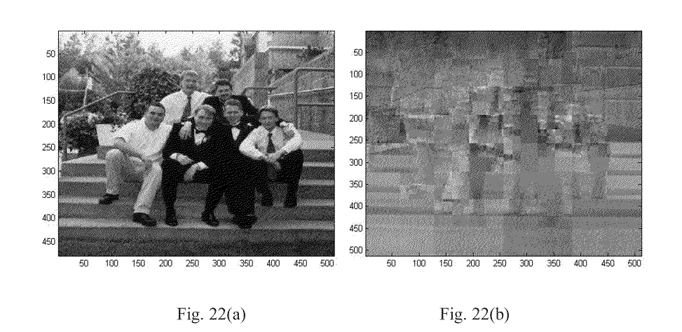

This error source prompted the addition of a smoothing process, which will be described with reference to FIG. 20. This smoothing step is represented as step 32 in the diagrams. The choice of data filtering is to average the gradient evaluated from the image estimate and averaged with the actual gradient measurement at the same location

In still another embodiment, wavelets are used to de-noise a wave-front using the HH part instead of simply eliminating the HH part. As was previously described, an intermediate step for solving for the wave-front in the proposed algorithm is the Haar wavelet decomposition. Therefore, de-noising techniques could be performed at this stage before proceeding to the final estimate to alleviate the effects of measurement noise in the input.

An alternate approach to de-noising is to threshold the noise based on the Poisson nature of photon noise.

Referring to FIG. 20, a method for reconstructing a digital image 100 according to another embodiment is provided. As shown, gradient data of the visual scene is obtained by measuring the gradient, as indicated at step 20, using differences between intensity pixels or by using a wave-front sensor (WFS), such as a Shack-Hartmann WFS(SH-WFS), for example. The data can be obtained at step 20 either at full resolution for measurement or coarsely sampled for lower resolution view finders. The resolution of the gradient data is then reduced to the resolution of the desired output, at step 22, and further reduced while portions of the Haar decomposition are extracted at step 24 to estimate the Haar decomposition. Once the Haar decomposition is complete, as indicated by reference numeral 26, the Haar synthesis and smoothing operation is performed by processing the Haar synthesis, at step 30, and then smoothing the result, at step 32. These steps are performed multiple times until the Haar synthesis is complete. Then, constant slope or other distortions are removed and the reconstructed image is sent to the view finder, image file or other image displaying device for viewing, as indicated at steps 34 and 36, respectively.

The Haar synthesis, which is generally the conversion from the Haar decomposition to an image, increases the resolution at each step. The result of the previous step plus a section of the Haar decomposition is used to produce a higher resolution image. The smoothing steps provided between each stage of the Haar synthesis smooth any errors that may be present as a result of noise contamination. The smoothing steps average the gradient of the image estimate with the measured gradient. Where there is no noise or errors present, the gradient of the image estimate and the measured gradient are equal. As such, there is no loss of accuracy when there is no noise or errors.

Methods of determining efficient implementations of the decomposition estimation technique and the HWSF will now be described.

An advantage of the methods of reconstructing an image of FIGS. 1 and 20 is low computation time and memory use. The method of FIG. 20 is uses the data structures of FIGS. 11 and 21. This is efficient because it does not include matrix memory allocations within for loops, which was a side effect of down sampling and up sampling.

FIG. 21 is a representation of all resolutions of the gradient data and is a possible data storage structure. It will be appreciated by a person skilled in the art that FIG. 21 represents one of many different options.

It will further be appreciated by a person skilled in the art that the two data sets of FIG. 21 could be fitted together to remove the white space.

Further, the method of FIG. 20 utilizes polyphase and lifting techniques to reduce computations with a goal of maintaining a static data structure.

FIG. 22(a) provides an example of how the method of FIG. 1 performs when the data is corrupted. FIG. 22(a) shows perfect reconstruction when ^{M}X and ^{M}Y are not altered whereas FIG. 22(b) shows the result when ^{M}Y is multiplied by negative one. This is an extreme case, but it shows the large square artifacts that manifest when using the Haar wavelets with corrupted data. The method of FIG. 20 provides an increase in the quality of reconstruction over the method of FIG. 1.

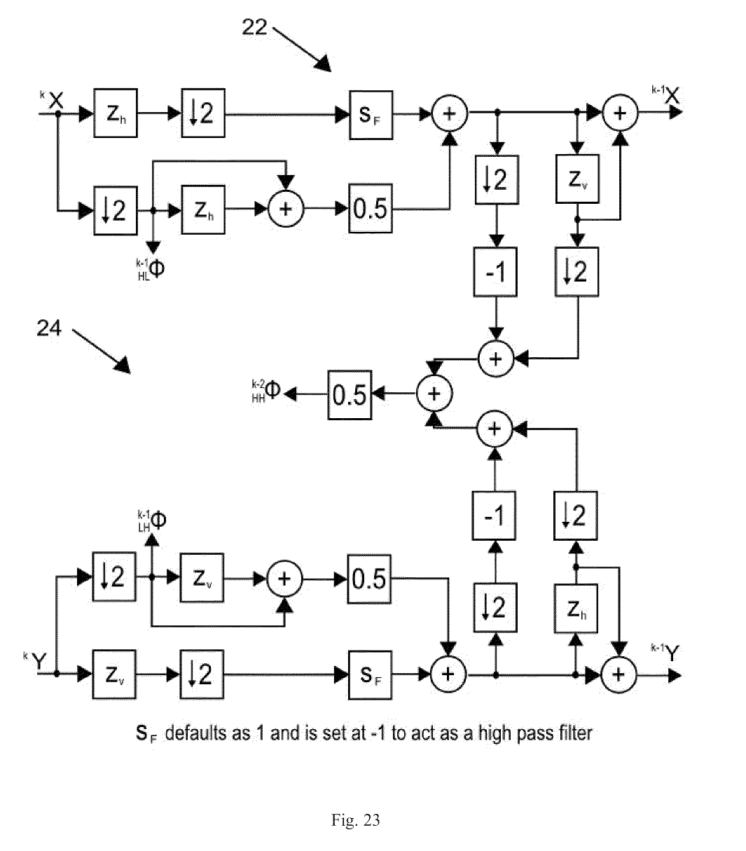

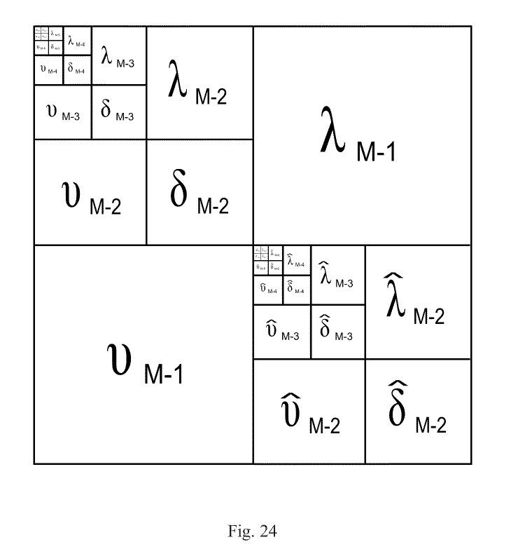

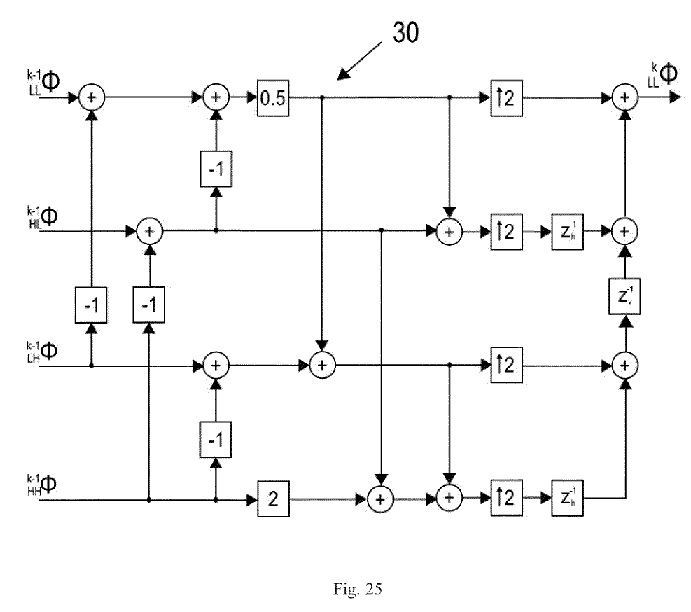

Referring to FIG. 23, a polyphase representation of the filterbanks is provided. The computation cost of FIG. 23 is 27N/16 adds and 9N/16 multiplies. These multiplies are by factors of two, so they could be implemented as single bit shifts to decrease computation time further. Scaling the computation cost by 4/3 results as 2.25N adds and 0.75N multiplies for each branch of the analysis. Therefore, the analysis of the gradient data costs 6N flops with the implementation of FIG. 23. This can be further reduced to 4.5N flops if the multiplies are implemented as bit shifts that are insignificant time cost compared to a flop.

FIG. 23 was developed in the following way. Since the signal is two dimensional, there are four combinations of low and high pass filtering: (i) H.,₀₀(zₕ,zᵥ) is low pass-low pass, (ii) H.,₀₁(zₕ,zᵥ) is low pass-high pass, (iii) H.,₁₀(zₕ,zᵥ) is high pass-low pass and (iv) H.,₁₁(zₕ,zᵥ) is high pass-high pass. The ‘.’ can be replaced by either x or y. Filtering occurs on each of the two gradient measurement signals, so there are a total of eight analysis filters that are applied to the data in order to obtain the decomposition of FIG. 7. These filters are provided in equations (35) to (42). These eight filters supply the six signal types by averaging the result of using (36) with (40) and averaging the result of (38) with (42).

$$\begin{matrix}{H}_{χ , 00} ( {z}_{h} , {z}_{v} ) = \frac{( {z}_{h}^{2} + 2 {z}_{h} + 1 ) ( {z}_{v}^{2} + 1 )}{2} & ( 35 ) \\ {H}_{χ , 01} ( {z}_{h} , {z}_{v} ) = \frac{( {z}_{h}^{2} + 2 {z}_{h} + 1 ) ( {z}_{v}^{2} - 1 )}{2} & ( 36 ) \\ {H}_{χ , 10} ( {z}_{h} , {z}_{v} ) = \frac{( {z}_{v}^{2} - 2 {z}_{v} + 1 ) ( {z}_{h}^{2} + 1 )}{2} & ( 37 ) \\ {H}_{χ , 11} ( {z}_{h} , {z}_{v} ) = \frac{( {z}_{v}^{2} - 2 {z}_{v} + 1 ) ( {z}_{h}^{2} + 1 )}{2} & ( 38 )\end{matrix}$$

The following filters for the other gradient signal are the same as above except for a transpose of filtering directions.

$$\begin{matrix}\begin{matrix}{H}_{γ , 00} ( {z}_{h} , {z}_{v} ) = \frac{( {z}_{v}^{2} + 2 {z}_{v} + 1 ) ( {z}_{h}^{2} + 1 )}{2} \\ = {H}_{χ , 00} ( {z}_{v} , {z}_{h} )\end{matrix} & ( 39 ) \\ \begin{matrix}{H}_{γ , 01} ( {z}_{h} , {z}_{v} ) = \frac{( {z}_{v}^{2} + 2 {z}_{v} + 1 ) ( {z}_{h}^{2} - 1 )}{2} \\ = {H}_{χ , 01} ( {z}_{v} , {z}_{h} )\end{matrix} & ( 40 ) \\ \begin{matrix}{H}_{γ , 10} ( {z}_{h} , {z}_{v} ) = \frac{( {z}_{h}^{2} - 2 {z}_{h} + 1 ) ( {z}_{v}^{2} + 1 )}{2} \\ = {H}_{χ , 10} ( {z}_{v} , {z}_{h} )\end{matrix} & ( 41 ) \\ \begin{matrix}{H}_{γ , 11} ( {z}_{h} , {z}_{v} ) = \frac{( {z}_{h}^{2} + 2 {z}_{h} + 1 ) ( {z}_{v}^{2} + 1 )}{2} \\ = {H}_{χ , 11} ( {z}_{v} , {z}_{h} )\end{matrix} & ( 42 )\end{matrix}$$

It is apparent from the above equations that the filters have a similar structure to each other. For example, (41) is the same filter as (35) except for a negative sign. Further, (39) is the same as (35) when the filtering directions are transposed. Therefore, by including s_{F}ε{−1,1} as the sign of the filter, the polyphase representation of (35) and (41) can be obtained simultaneously. Transposing the filter directions obtains (39) and (37). Although the filters are two dimensional, the polyphase decomposition can be approached by treating each orthogonal direction as separate one dimensional problems. This approach is simplified since one of the four polyphase filters is equal to zero.

$$\begin{matrix}\begin{matrix}{H}_{χ , 00} ( {z}_{h} , {z}_{v} , {s}_{F} ) = {H}_{γ , 10} ( {z}_{h} , {z}_{v} , - {s}_{F} ) \\ = \frac{( {z}_{h}^{2} + 2 {s}_{F} {z}_{h} + 1 ) ( {z}_{v}^{2} + 1 )}{2} \\ = ( \frac{{z}_{h}^{2} + 1}{2} + {z}_{h} ( {s}_{F} ) ) ( {z}_{v}^{2} + 1 ) \\ = [ \begin{matrix}{H}_{χ , 00 , h , 0} ( {z}_{h}^{2} ) + \\ {z}_{h} {H}_{χ , 00 , h , 1} ( {z}_{h}^{2} , {s}_{F} )\end{matrix} ] … \\ [ \begin{matrix}{H}_{χ , 00 , v , 0} ( {z}_{v}^{2} ) + \\ {z}_{v} {H}_{χ , 00 , v , 1} ( {z}_{v}^{2} )\end{matrix} ]\end{matrix} & ( 43 ) \\ {H}_{χ , 00 , h , 0} ( {z}_{h} ) = \frac{{z}_{h} + 1}{2} & ( 44 ) \\ {H}_{χ , 00 , h , 1} ( {z}_{h} , {s}_{F} ) = {s}_{F} & ( 45 ) \\ {H}_{χ , 00 , v , 0} ( {z}_{v} ) = {z}_{v} + 1 & ( 46 ) \\ {H}_{γ , 00 , v , 1} ( {z}_{v} ) = 0 & ( 47 )\end{matrix}$$

This process is repeated for the other three pairs of filters and the result is represented in FIG. 23. Significant computational savings are obtained by computing the horizontal direction of H_{χ,00}(zₕ,zᵥ) before the vertical portion since this is common to H_{χ,01} (zₕ,zᵥ) as shown in FIG. 23.

For the high frequency analysis branch used to estimate _{HH}^{M-1}Φ, the variable s_{F} is set to −1 and the inputs are swapped when the high frequency analysis branch is begun. The subsequent blocks in this branch have s_{F}=1 and are used the same way as in the low frequency analysis branch of FIG. 13. This way, the low frequency analysis filterbank structure can be reused to obtain the high frequency analysis.

H_{γ,10}(zₕ,zᵥ)=H_{χ,00}(zₕ,zᵥ,−1) (48)

H_{γ,11}(zₕ,zᵥ)=H_{χ,01}(zₕ,zᵥ,−1) (49)

H_{χ,10}(zₕ,zᵥ)=H_{γ,00}(zₕ,zᵥ,−1) (50)

H_{χ,11}(zₕ,zᵥ)=H_{γ,01}(zₕ,zᵥ,−1) (51)

It was determined that computation of the Haar synthesis filterbank can be more efficient with a lifting implementation. Such an implementation overwrites the signals directly in order to increase numerical stability and reduce computation time and memory use. The simplicity of the Haar wavelet is an advantage for determining this implementation since the support of the wavelet shapes are all contained within 2×2 pixels at the given resolution. Assuming that the data is ordered appropriately, the analysis filters of 2×2 blocks of the 2-D data followed by 2-D down sampling by a factor of 2 becomes indistinguishable from analysis filters of a 4×1 line of data followed by 1-D down sampling by a factor of 4.

The 2-D lifting realization for the filters on the left side of (52) to (55) can be obtained by the same process that is used to find the 1-D lifting realization of the filters on the right hand side of (52) to (55).

$$\begin{matrix}{H}_{00} ( {z}_{h} , {z}_{v} ) = \frac{{z}_{h} {z}_{v} + {z}_{v} + {z}_{h} + 1}{2} ↔ {H}_{0} ( z ) \frac{{z}^{3} + {z}^{2} + z + 1}{2} & ( 52 ) \\ {H}_{10} ( {z}_{h} , {z}_{v} ) = \frac{{z}_{h} {z}_{v} - {z}_{v} + {z}_{h} - 1}{2} ↔ {H}_{1} ( z ) \frac{{z}^{3} - {z}^{2} + z - 1}{2} & ( 53 ) \\ {H}_{01} ( {z}_{h} , {z}_{v} ) = \frac{{z}_{h} {z}_{v} + {z}_{v} - {z}_{h} - 1}{2} ↔ {H}_{2} ( z ) \frac{{z}^{3} + {z}^{2} - z - 1}{2} & ( 54 ) \\ {H}_{11} ( {z}_{h} , {z}_{v} ) = \frac{{z}_{h} {z}_{v} - {z}_{v} - {z}_{h} + 1}{2} ↔ {H}_{3} ( z ) \frac{{z}^{3} - {z}^{2} - z + 1}{2} & ( 55 )\end{matrix}$$

This means that the 2-D lifting realization can be determined via 1-D methods. The polyphase matrix of the analysis filter becomes

$$\begin{matrix}{H}_{p} ( z ) = \frac{1}{2} [ \begin{matrix}1 & 1 & 1 & 1 \\ - 1 & 1 & - 1 & 1 \\ - 1 & - 1 & 1 & 1 \\ 1 & - 1 & - 1 & 1\end{matrix} ] & ( 56 ) \\ det {H}_{p} ( z ) = 1 & ( 57 )\end{matrix}$$

The determinant of H_{P}(z) is a monomial, so synthesis with FIR filters is possible. It is known that for a shift free perfect reconstruction filterbank

Hₚ(z)Gₚ(z)=I (58)

Then letting Gₚ(z)=C₀(z)C₁(z)C₂(z)C₃(z)S₀(z), an implementation of Gₚ(z) can be determined using elementary column operations on Hₚ(z). This approach provides a solution with 3.5 flops per pixel.

$${H}_{p} ( z ) ( {\prod }_{k = 0}^{3} {C}_{k} ( z ) ) {S}_{0} ( z ) = I \\ where \\ {C}_{0} ( z ) = [ \begin{matrix}1 & 0 & 0 & 0 \\ 1 & 1 & 0 & 0 \\ 0 & 0 & 1 & 0 \\ 0 & 0 & 1 & 1\end{matrix} ] \\ {C}_{1} ( z ) = [ \begin{matrix}1 & 0 & 0 & 0 \\ 0 & 1 & 0 & 0 \\ 1 & 0 & 1 & 0 \\ 0 & 1 & 0 & 1\end{matrix} ] \\ {C}_{2} ( z ) = [ \begin{matrix}1 & - 1 / 2 & 0 & 0 \\ 0 & 1 & 0 & 0 \\ 0 & 0 & 1 & - 1 / 2 \\ 0 & 0 & 0 & 1\end{matrix} ] \\ {C}_{3} ( z ) = [ \begin{matrix}1 & 0 & - 1 / 2 & 0 \\ 0 & 1 & 0 & - 1 / 2 \\ 0 & 0 & 1 & 0 \\ 0 & 0 & 0 & 1\end{matrix} ] \\ {S}_{0} ( z ) = [ \begin{matrix}0.5 & 0 & 0 & 0 \\ 0 & 1 & 0 & 0 \\ 0 & 0 & 1 & 0 \\ 0 & 0 & 0 & 2\end{matrix} ] \qquad ( 59 )$$

It was determined that the number of computations can be further reduced by adjusting the order of operations. The scaling required by S₀(z) can be applied deeper into the synthesis process to avoid the scaling required by C₃(z) and C₂(z). Instead Gₚ(z) is implemented with 2.5 flops per pixel as

$${G}_{p} ( z ) = {C}_{0} ( z ) {C}_{1} ( z ) {S}_{0} ( z ) {C}_{2}^{′} ( z ) {C}_{3}^{′} ( z ) \\ where \\ {C}_{2}^{′} ( z ) = [ \begin{matrix}1 & - 1 & 0 & 0 \\ 0 & 1 & 0 & 0 \\ 0 & 0 & 1 & - 1 \\ 0 & 0 & 0 & 1\end{matrix} ] \\ {C}_{3}^{′} ( z ) = [ \begin{matrix}1 & 0 & - 1 & 0 \\ 0 & 1 & 0 & - 1 \\ 0 & 0 & 1 & 0 \\ 0 & 0 & 0 & 1\end{matrix} ] \qquad ( 60 )$$

This is the implementation shown in FIG. 25, which is the schematic representation of the lifting realization of the HWSF. It is expected that in an efficient implementation that the multiplications by 0.5, 2 and −1 could be implemented with out the use of flops. Changing a number by a factor of two is the same as shifting the data bits by one position. Multiplication by negative 1 followed by addition is subtraction.

The well known criterion for least-square solutions of image reconstruction from gradient measurements will now be described. It is well known in the art that the least squares optimal solution is one that the Laplacian of the result is equal to the divergence of the partial derivatives.

$${∇}^{2} ( {}_{LL}^{M} \tilde{Φ} ) = ∇ \cdot ( {}^{M} X {\vec{u}}_{x} + {}^{M} Y {\vec{u}}_{y} ) \\ \frac{{\partial }^{2} ( {}_{LL}^{M} \tilde{Φ} )}{\partial {x}^{2}} + \frac{{\partial }^{2} ( {}_{LL}^{M} \tilde{Φ} )}{\partial {y}^{2}} = \frac{\partial ( {}^{M} X )}{\partial x} + \frac{\partial ( {}^{M} Y )}{\partial y} \qquad ( 61 )$$

Forcing equation (61) to be true requires an iterative process and is the basis of many iterative Poisson solvers.

It is understood that the Poisson equation approach may be used to smooth the results of the HWSF.

A method developed to smooth the HWSF result in the presence of gradient measurements as an alternate to the Poisson equation will now be described.

Although the method shown in FIG. 13 is very fast compared to other methods, the result does not utilize one quarter of the measured data. This discarding of data occurs at each stage of the analysis pipe line. This data is redundant and is not required to make a perfect reconstruction in a noise free and modeling error free scenario.

In practice the data may not be perfectly modeled by (5) and (6) as with the model of (9) and (10). Also, there will be measurement noise to corrupt the input data. Therefore it is desirable to find a use for this redundant data to reduce the effects of these error sources.

In the method of FIG. 20, the excess data will be directly averaged into each stage of the synthesis process. This filterbank based approach may then be evaluated against (61).

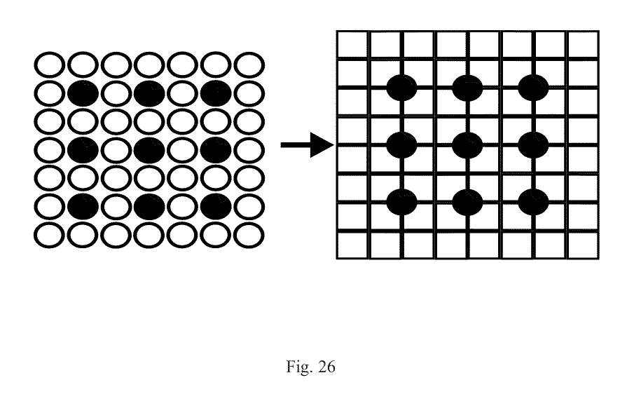

As can be seen from FIG. 26, the black circles each correspond to an independent 2×2 block of pixels. Each of these blocks can be decomposed with a single stage of Haar analysis. Then the X and Y data related to the black circles can be averaged with the respective decomposition signals. This result is then synthesized. From the previous section it is known that analysis and synthesis can each be implemented in 10 flops per quad cell (2.5 flops per pixel). Averaging the horizontal and vertical slope measurements would add another 4 flops for a total of 24 flops.

Rather than apply these steps separately, a lifting realization was developed for the full process so that the computations could be performed more efficiently. The filtering process can be represented by the polyphase matrices.

$$\begin{matrix}( {↓}_{2} ) [ \begin{matrix}{\tilde{α}}_{k} \\ {z}_{h} {\tilde{α}}_{k} \\ {z}_{v} {\tilde{α}}_{k} \\ {z}_{d} {\tilde{α}}_{k}\end{matrix} ] = {p}_{p} ( z ) ( {↓}_{2} ) [ \begin{matrix}{α}_{k} \\ {z}_{h} {α}_{k} \\ {z}_{v} {α}_{k} \\ {z}_{d} {α}_{k} \\ {z}_{d} {χ}_{k} \\ {z}_{d} {γ}_{k}\end{matrix} ] \\ where & ( 62 ) \\ \begin{matrix}{P}_{p} ( z ) = {H}_{p}^{- 1} ( z ) [ \begin{matrix}1 & 0 & 0 & 0 & 0 & 0 \\ 0 & 0.5 & 0 & 0 & 0.5 & 0 \\ 0 & 0 & 0.5 & 0 & 0 & 0.5 \\ 0 & 0 & 0 & 1 & 0 & 0\end{matrix} ] [ \begin{matrix}{H}_{p} ( z ) & 0 \\ 0 & {I}_{2}\end{matrix} ] \\ = \frac{1}{4} [ \begin{matrix}3 & 0 & 0 & 1 & - 1 & - 1 \\ 0 & 3 & 1 & 0 & 1 & - 1 \\ 0 & 1 & 3 & 0 & - 1 & 1 \\ 1 & 0 & 0 & 3 & 1 & 1\end{matrix} ]\end{matrix} & ( 63 )\end{matrix}$$

The 4×6 matrix in the center of the first row of (63) represents the averaging of the slopes found by decomposition of _{LL}^{k}Φ with the slopes found by measurement. The resulting matrix is not square, so for the lifting realization the 4×4 section on the left was considered independently from the 4×2 section on the right. Implementing (63) directly would cost 20 flops per quad cell. Instead, this matrix is decomposed in pieces as (64) and (65).

$$\begin{matrix}\frac{1}{4} [ \begin{matrix}3 & 0 & 0 & 1 \\ 0 & 3 & 1 & 0 \\ 0 & 1 & 3 & 0 \\ 1 & 0 & 0 & 3\end{matrix} ] = [ \begin{matrix}1 & 0 & 0 & 0 \\ 0 & 1 & 0 & 0 \\ 0 & 1 & 1 & 0 \\ 1 & 0 & 0 & 1\end{matrix} ] [ \begin{matrix}1 & 0 & 0 & 0 \\ 0 & 1 & 0 & 0 \\ 0 & 0 & 1 / 2 & 0 \\ 0 & 0 & 0 & 1 / 2\end{matrix} ] [ \begin{matrix}1 & 0 & 0 & 1 / 4 \\ 0 & 1 & 1 / 4 & 0 \\ 0 & 0 & 1 & 0 \\ 0 & 0 & 0 & 1\end{matrix} ] [ \begin{matrix}1 & 0 & 0 & 0 \\ 0 & 1 & 0 & 0 \\ 0 & - 1 & 1 & 0 \\ - 1 & 0 & 0 & 1\end{matrix} ] & ( 64 ) \\ \frac{1}{4} [ \begin{matrix}- 1 & - 1 \\ 1 & - 1 \\ - 1 & 1 \\ 1 & 1\end{matrix} ] = [ \begin{matrix}0 & - 1 \\ 1 & 0 \\ - 1 & 0 \\ 0 & 1\end{matrix} ] [ \begin{matrix}1 & - 1 \\ 0 & 1\end{matrix} ] [ \begin{matrix}0.5 & 0 \\ 0 & 0.25\end{matrix} ] [ \begin{matrix}1 & 0 \\ 1 & 1\end{matrix} ] & ( 65 )\end{matrix}$$

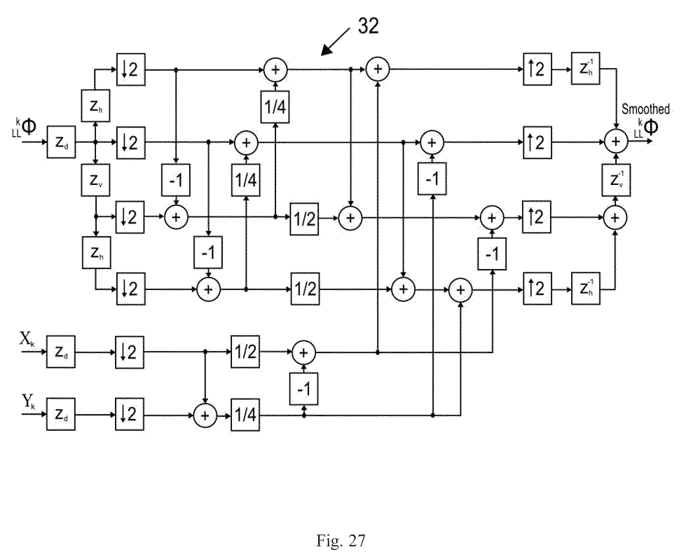

Implementing the lifting approach reduces the computation cost to 18 flops per quad cell. This may only be a reduction by 0.5 flops per pixel, but it also does not require extra temporary memory space to compute. The resulting filterbank is shown in FIG. 27.

It will be appreciated by a person skilled in the art that the process of (65) could be moved to the decomposition step.

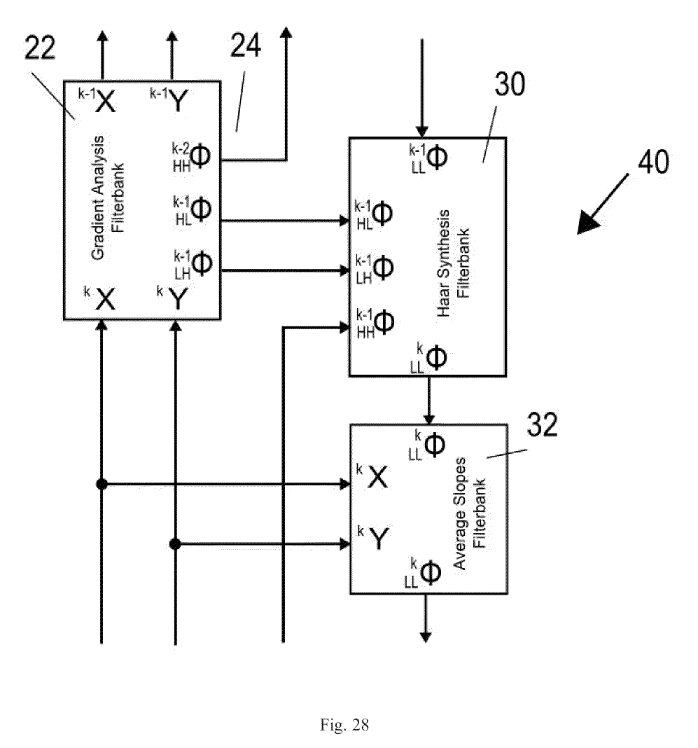

FIG. 28 shows the interconnections of the three main recursive components of the methods for reconstructing an image. These interconnections are represented as a whole as by reference numeral 40.

The sub steps are those of the high level diagram of FIG. 20. The reduction of resolution of step 22 and the extraction of decomposition components of step 24 are performed in the gradient analysis filterbank. Step 30 is the HWSF and step 32 is the smoothing step that averages the slopes (i.e. gradients).

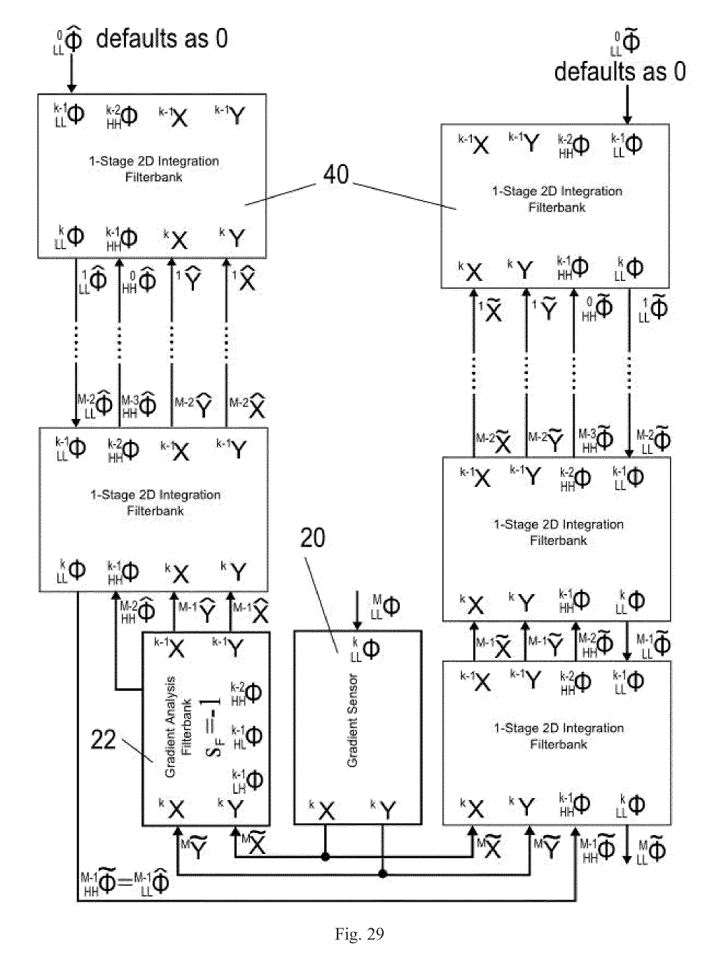

FIG. 29 represents how the three main recursive components of FIG. 28 are used recursively to provide the final estimate of the image from the gradient measurements. This is a schematic diagram of the high level diagram of FIG. 20.

The computational complexity of the analysis and synthesis steps can be established based on the complexity of the 2-dimensional separable DWT. Both the Analysis and Synthesis steps involve convolutions with separable wavelet filters followed by down-sampling in both dimensions and thus, the computational complexity will be of order O(N), where N=2^{M}×2^{M}. Thus, the proposed Analysis and Synthesis steps are scaling linear with the number of sensors. The constant coefficient before the linear term N depends on the type of filters used and on the implementation.

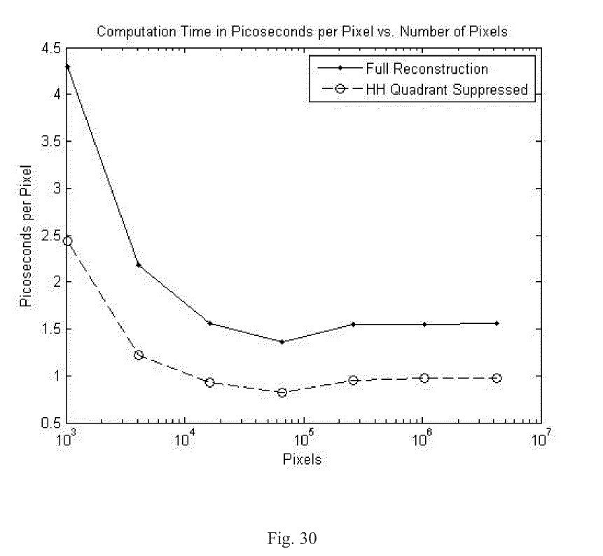

To evaluate the computational complexity of the methods of FIG. 1 and FIG. 20 and the effect of neglecting the HH quadrant on the computational speed, wave-fronts of various resolutions were generated and the computation times are given as FIG. 30. This shows that the computation time is linear with the number of pixels for large numbers of pixels. This test was performed on an embodiment of the invention that was 13N flops for the full reconstruction and 8N flops while neglecting the high frequency quadrant.

It also shows that the algorithm requires at least a 128×128 reconstruction for the computation time to be significant compared to MatLab's overhead because the time per pixel is significantly decreasing until that size. These computations were made using MatLab by way of example and thus the computation times are not indicative of computation time in a real time implementation.

The computation costs for an inefficient method of FIG. 13 and the method of FIG. 29 with the derived efficiency improvements are shown in Table 1. When there is a factor of two down sampling in 2-D, computing M-stages costs no more than 4/3 of the computation cost of a single stage. There are two M-stage analysis branches, so the full analysis costs 8/3 of 1 stage. There is one M-stage synthesis branch and one M−1-stage synthesis branch, so synthesis costs 5/3 of one stage since 4/3+(1/4)(4/3)=5/3. This 5/3 factor also applies to the slope averaging cost.

An interesting result is that the considerable savings in computation time of these new implementations are more than the cost of the slope averaging stage. Without slope averaging, the analysis and synthesis stages can be implemented for a total of 10.17N flops where N is the number of pixels in the final synthesis result, a savings of 45.83N flops over the original implementation. With the slope averaging process, the cost is 17.67N flops, which is still 38.33N flops faster than the original implementation.

TABLE 1
Computations per pixel of synthesized data

| | | | | | | | | Total |
|---|---|---|---|---|---|---|---|---|
| | | Gradient Analysis | | Data Synthesis | | Slope Averaging | | All |
| | | 1 Stage | All Stages | 1 Stage | All Stages | 1 Stage | All Stages | Stages |
| An inefficient | Adds | 6 | 16 | 3 | 5 | N/A | N/A | 21 |
| implementation | Shifts | 12.5 | 33.33 | 1 | 1.67 | N/A | N/A | 35 |
| of Method of | Total | 18.5 | 49.33 | 4 | 6.67 | N/A | N/A | 56 |
| FIG. 13 | | | | | | | | |
| An efficient | Adds | 1.69 | 4.5 | 2 | 3.33 | 3 | 5 | 12.83 |
| implementation | Shifts | 0.56 | 1.5 | 0.50 | 0.83 | 1.5 | 2.5 | 4.83 |
| of Method of | Total | 2.25 | 6 | 2.50 | 4.17 | 4.5 | 7.5 | 17.67 |
| FIG. 29 | | | | | | | | |

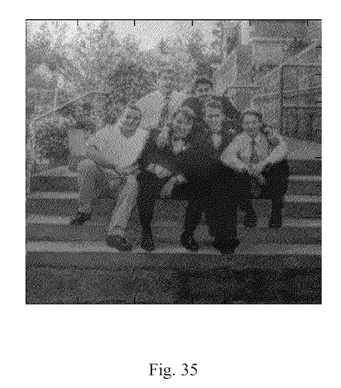

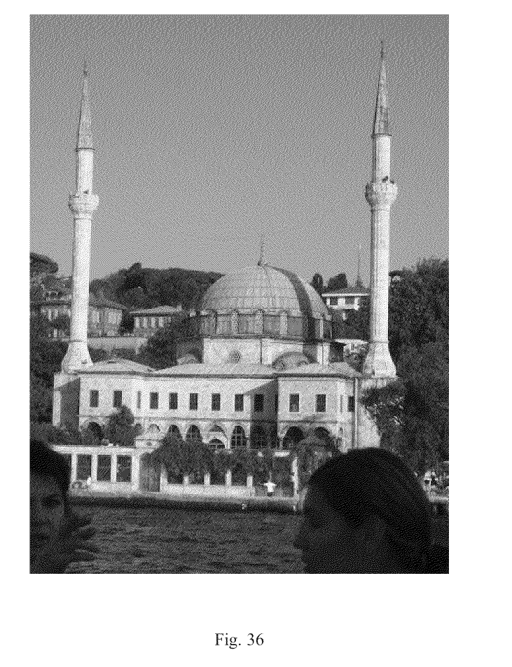

For the slope averaging process, the result should be unchanged when data corruption does not exist. FIG. 34 shows the reconstructed image when the Signal to Noise Ratio (SNR) is infinite. The difference between the reconstruction and the original picture is also shown to indicate there is no error aside from the error caused by seeding the synthesis process with _{LL}⁰\tilde{Φ}=_{LL}⁰\hat{Φ}=0.

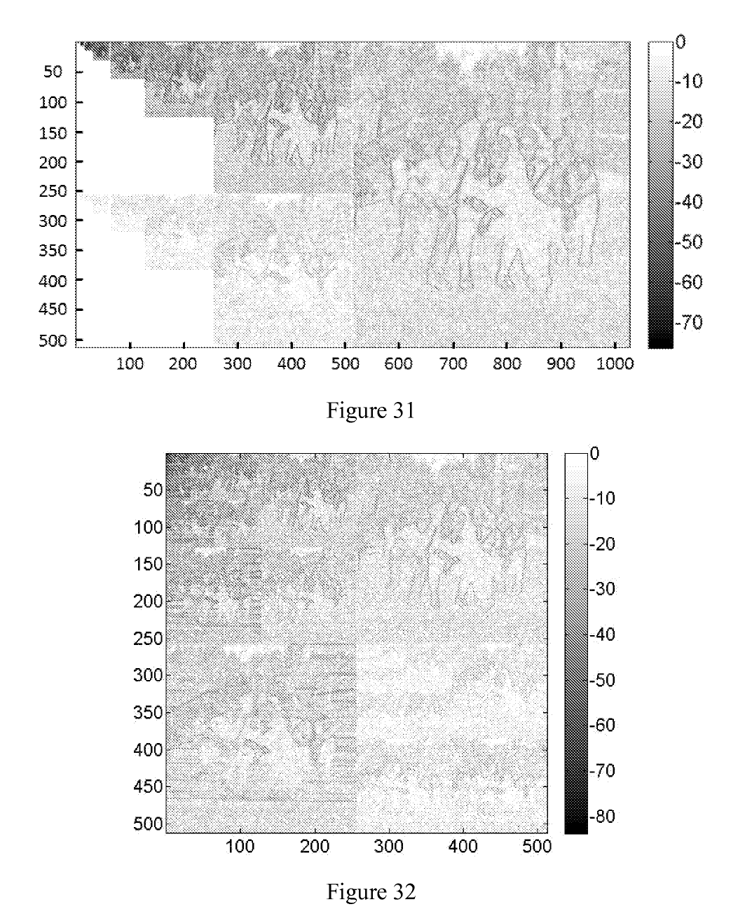

FIG. 31 is a combination of the analysis of X and ^{M}Y in which the gradient power is 20 log₁₀(|(^{M}X)+j(^{M}Y)|). Black is the maximum power and is normalized to 0 dB. White is minimum power and is truncated at −80 dB. What can be seen from FIG. 31 is the low frequency analysis (top half) has more power than the high frequency analysis (bottom half) since black relates to the highest power. This can also be seen in FIG. 32 where the lower right hand quadrant is very light colored indicating the low power related to high frequency shapes.

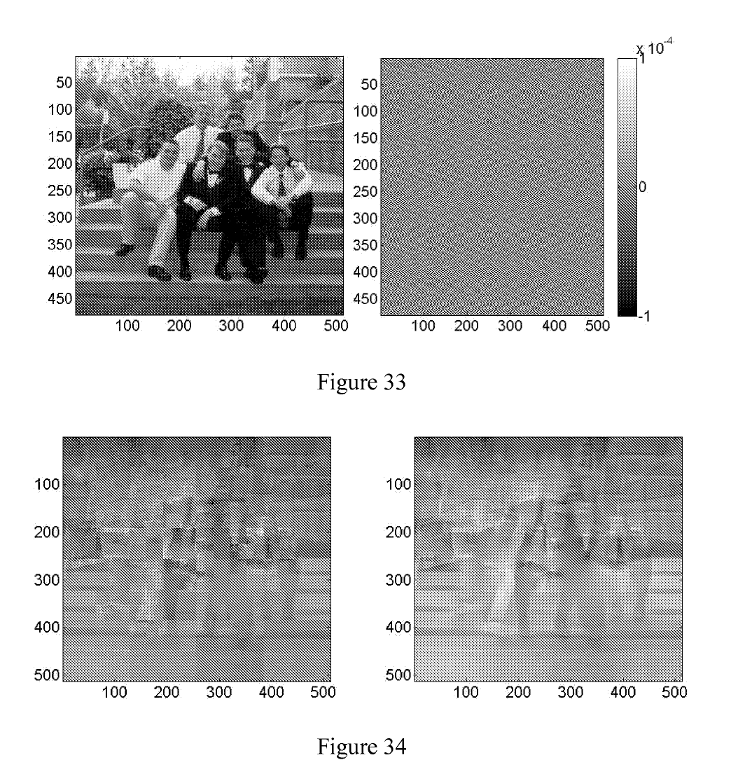

FIG. 33 shows that the noiseless data processed with the slope averaging filterbank produces an errorless result (ignoring the effect of _{LL}⁰\tilde{Φ} and _{LL}⁰\hat{Φ}). This demonstrates that there isn't a negative impact on the noiseless case by including slope averaging aside from computation time.

Referring to FIGS. 34(a) and (b), one way to study how image reconstruction methods respond to corrupted data is to use the wrong sign convention on one of the gradient measurement signals. The method of FIG. 1 result is very blocky, as shown in FIG. 34(a), which is a recognizable feature of the 2-D Haar wavelets. However, the method of FIG. 20 with slope averaging is considerably smoother, as shown in FIG. 34(b). Naturally, when the data is wrong the result is wrong, but the smoothed result retains recognizable features of the image and is reminiscent of a special effect to make a ghostly image.

FIG. 36 is provided to demonstrate that visually acceptable results can be obtained from gradient data that is coarsely approximated. In this example, there are only three possibilities for the gradient data; (i) greater than eight becomes one, (ii) less than negative eight becomes negative one (iii) remaining small values are 0. It is a surprising result that such a coarse “sensor” can result in high detail results where each individual photographed is recognizable. The result is far from accurate in a mathematical sense, but is a reasonable result when viewed by the human eye given the input error.

FIG. 35 can be compared to FIG. 33 to view the retention of image detail despite loss of gradient detail. Visual quality is reduced as a trade off with sensor quality. This allows images to be obtained from detectors that only detect as little as whether the gradient is beyond a given threshold. This aspect may be useful for low quality imaging systems, such as low cost grayscale security cameras and toy cameras as examples.

It has been shown that the least squares solution is one where the divergence of the gradient measurements is equal to the Laplacian of the data estimate (61). The Laplacian operator was implemented as a 2-D FIR filter given as

$${∇}^{2} {\tilde{α}}_{m} \approx [ \begin{matrix}- 1 & 0 & - 1 \\ 0 & 4 & 0 \\ - 1 & 0 & - 1\end{matrix} ] ⋆ {\tilde{α}}_{M} \qquad ( 66 )$$

The corresponding filters on the signals ^{M}X and ^{M}Y to obtain the divergence with this sign convention is

$$∇ \cdot ( \frac{\partial ( {}_{LL}^{M} \tilde{Φ} )}{\partial x} {\vec{u}}_{x} + \frac{\partial ( {}_{LL}^{M} \tilde{Φ} )}{\partial y} ) \approx [ \begin{matrix}- 1 & 1 \\ - 1 & 1\end{matrix} ] ⋆ ( {}^{M} X ) + [ \begin{matrix}- 1 & - 1 \\ 1 & 1\end{matrix} ] ⋆ ( {}^{M} Y ) \qquad ( 67 )$$

These operations were tested to ensure that the equality in (61) exists in the no noise case. Equality in (61) indicates the least squares solution. When noise is present it was determined that the Laplacian of the data estimate does not equal the divergence of the measurements.

However, the process of averaging in the unused data has considerably improved the Laplacian of the estimates. The first row of Table 2 shows that the normalized rms difference between the Laplacian of the estimate and the divergence of the measurements is reduced from 7% to 3.7% by including the slope averaging step. Comparing the Laplacians of the original signal to the estimate, the normalized rms difference dropped from 8.3% to 5.8%. When comparing the standard deviation between the estimate and the original image, there is only 1.9% error.

TABLE 2
Normalized standard deviations of the Laplacian of the
estimate from the accepted least-squares criteria as well
as from the Laplacian of the true data.

| | Without Slope | With Slope |
|---|---|---|
| SNR = 20 | Averaging | Averaging |
| $\frac{‖ {∇}^{2} ( {}_{LL}^{9} \tilde{Φ} ) - ∇ \cdot ( {}^{9} X {\vec{u}}_{x} {+}^{9} Y {\vec{u}}_{y} ) ‖}{‖ {∇}^{2} ( {}^{9} Φ ) ‖}$ | 0.0702 | 0.0371 |
| $\frac{‖ {∇}^{2} ( {}_{LL}^{9} \tilde{Φ} ) - {∇}^{2} ( {}^{9} Φ ) ‖}{‖ {∇}^{2} ( {}^{9} Φ ) ‖}$ | 0.0830 | 0.0579 |

Therefore, there are still further improvements that can be made to optimize the result. It will be appreciated by a person skilled in the art that an alternative smoother may be used.

The most straight forward approach to solving for the data from gradient measurements is the pseudo-inverse of the gradient model. In this section, let G represent the discrete model of ∇ given as the Fried model in (5) and (6). This is a least squares approach, but the computation cost is prohibitive for large matrices due to the O(N³) cost to obtain the pseudo-inverse. Instead a 32×32 example is chosen.

$$\begin{matrix}[ \begin{matrix}{}^{5} X \\ {}^{5} Y\end{matrix} ] = G ( {}^{5} Φ ) & ( 68 ) \\ {}_{LL}^{5} \tilde{Φ} = {G}^{†} [ \begin{matrix}{}^{5} X + {η}_{x} \\ {}^{5} Y + {η}_{y}\end{matrix} ] & ( 69 )\end{matrix}$$

Where η is the noise signal chosen to be zero mean Gaussian white noise with a magnitude chosen to cause the SNR to be 20. The computation cost of (69) is approximately 4N². Computing the singular value decomposition (SVD) to obtain the pseudo-inverse for this 32×32 example required 72 seconds (1922×1024 size pseudo-inverse). A 16×16 test (450×256 sized pseudo-inverse) required 0.6 seconds to compute the (SVD), which supports the claim that the process scales in a cubic manner. Assuming that the computation scaled as O(N³), it would take over 38 years to compute the pseudo-inverse in this manner to obtain the 512×512 results shown in this paper (522,242×262,144 sized pseudo-inverse). This is optimistic since one of the two matrices would be at least 250 Gigabytes and the other would be at least 500 Gigabytes, so the mathematics would require constant hard drive access. These are the primary reasons why such a small example is chosen.

It was determined that without averaging the slopes, the standard deviation of the error is 10% worse than with slope averaging at the 32×32 scale. This grows to 20% at the 512×512 scale. However, the improvement in visual quality of the results is much more significant.

TABLE 3
Normalized standard deviation of reconstruction error

| | Without Slope | With Slope | |
|---|---|---|---|
| SNR = 20 | Averaging | Averaging | Pseudo-Inverse |
| $\frac{‖ {}_{LL}^{5} \tilde{Φ} - {}^{5} Φ ‖}{‖ {}^{5} Φ ‖}$ | 0.0439 | 0.0393 | 0.0307 |

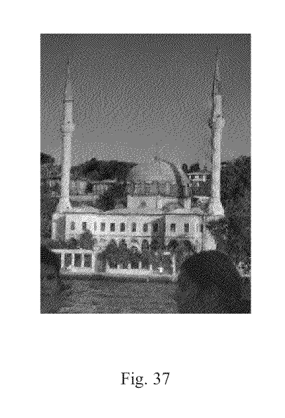

Referring to FIG. 36, a color image reconstruction is shown. The image is reconstructed from the full resolution gradient data with no measurement of light level. FIG. 37 shows the corresponding reconstruction of a color image for a view finder. In this example, the view finder was supplied with sampled gradient data to reduce computation cost.

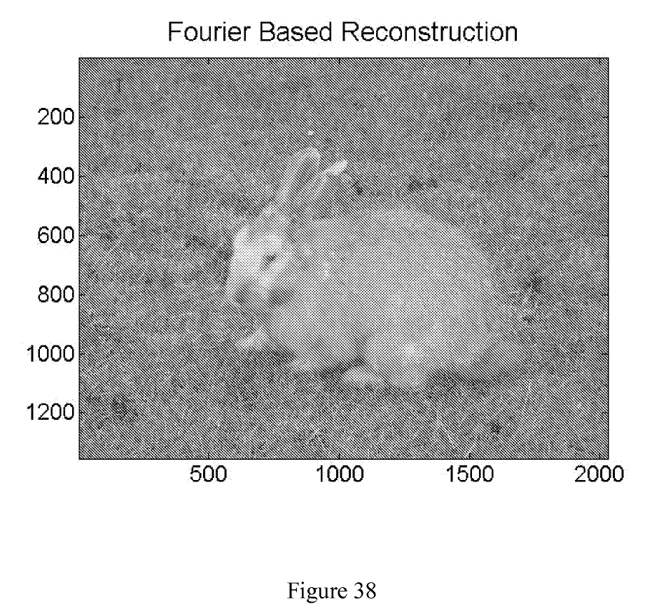

Referring to FIG. 38, an image that is the result of using the Fourier transform method to obtain a full resolution color image from gradient data.

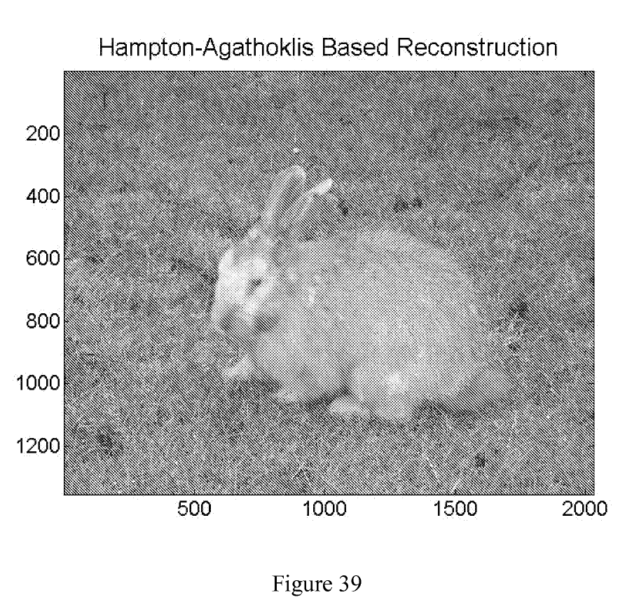

FIG. 39 shows an image that is example of the result of using the method of FIG. 20 to obtain a full resolution color image from gradient data with greatly reduced computation cost.

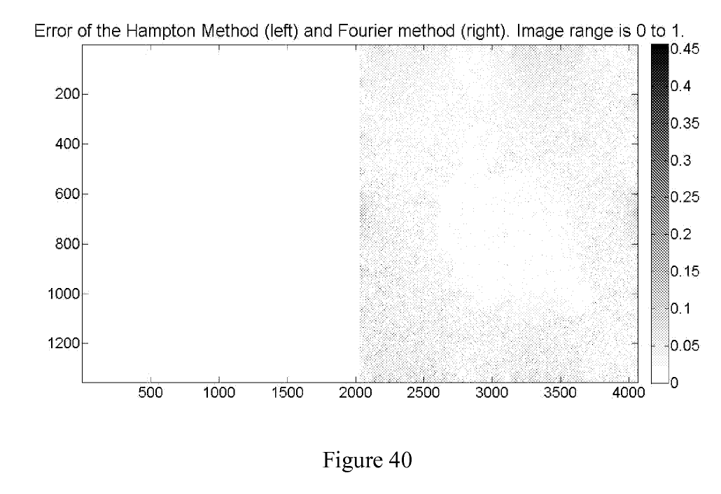

FIG. 40 shows the error generated by the method of FIG. 20 (left) and the Fourier transform method (right). The error shown is the difference between the true red color component and the estimated result of each method. The red color is normalized to a range of 0 to 1 so the error range of the Fourier transform method from under −0.2 to over 0.25 is very significant.

It will be appreciated by a person skilled in the art that the method of reconstructing a digital image may be applied to any type of device that uses digital images. Types of suitable devices include: cameras provided in mobile phones, cameras provided in laptop computers and digital copiers, for example. Further, the digital images may be grayscale or colored.

Further, the process could be applied to reconstruct any form of 2-D data that is measured by gradient sensors and is not limited to photography images.

The methods of reconstructing digital images of FIGS. 1 and 20 provide the ability to regulate the lighting of pictures based on a particular small area of the picture, rather than adjusting the aperture of a camera, which affects the lighting of a picture uniformly across the entire picture. The methods allow the end user to take pictures in situations having areas of both extreme light and extreme dark and obtain a result that is not silhouetted, given an implemented gradient camera. In addition, the simpler design of algorithms corresponding to the methods may result in smaller and simpler chip design and reduced manufacturing costs.

Specific embodiments have been shown and described herein. However, modifications and variations may occur to those skilled in the art. All such modifications and variations are believed to be within the scope and sphere of the present invention.

### APPENDIX I

The proof for how the gradient data can be transformed into the Haar decomposition is entirely based on algebraic manipulation of the standard HWAF and HWSF. The approach of the following algebra is to move the high pass filtering step that occurs at the end of the standard HWAF to the beginning via the noble identities. The model of a gradient sensor includes these high pass filters, so once the high pass filter is the first step of the filterbank it is trivial to move such filters out of the filterbank and into the sensor model.

The main steps of developing (21) to (33) from (15) to (18) are given in this section.

HL and LH quadrants: (21) and (22) follow directly from (16) and (17) for m=1 and the definitions of ^{M}\tilde{X} and ^{M}\tilde{Y} given by (7) and (8).
LL quadrant: To derive (25), first (16) is factored to obtain an expression for _{LH}^{M-m}\tilde{Φ} which involves the available gradient data ^{M}\tilde{Y} instead of the image data ^{M}φ as in (A.1). The use of square brackets is to help indicate how the algebraic expansion in the second line relates to the first line. These brackets are dropped for the reordering in the third line and finally ^{M}φH_{L}(zₕ)Hₕ(zᵥ) is directly replaced by ^{M}\tilde{Y} through the use of (8). The _{HL}^{M-m}\tilde{Φ} and _{HH}^{M-m}\tilde{Φ} terms are factored in similar ways.

$$\begin{matrix}{}_{LH}^{M - m} \tilde{Φ} = {↓}_{{2}^{m}} \{ {}^{M} Φ [ {H}_{H} ( {z}_{v}^{{2}^{m - 1}} ) ] [ {\prod }_{k = 0}^{m - 1} {H}_{L} ( {z}_{h}^{{2}^{k}} ) ] {\prod }_{k = 0}^{m - 2} {H}_{L} ( {z}_{v}^{{2}^{k}} ) \} \\ = {↓}_{{2}^{m}} \{ \begin{matrix}{}^{M} Φ [ {\sqrt{2}}^{m - 1} {H}_{H} ( {z}_{v} ) {\prod }_{k = 0}^{m - 2} {H}_{L} ( {z}_{v}^{{2}^{k}} ) ] … … \\ [ {H}_{L} ( {z}_{h} ) {\prod }_{k = 1}^{m - 1} {H}_{L} ( {z}_{h}^{{2}^{k}} ) ] {\prod }_{k = 0}^{m - 2} {H}_{L} ( {z}_{v}^{{2}^{k}} )\end{matrix} \} \\ = {\sqrt{2}}^{m - 1} {↓}_{{2}^{m}} \{ \begin{matrix}{}^{M} Φ {H}_{L} ( {z}_{v} ) {H}_{H} ( {z}_{V} ) … … \\ {\prod }_{k = 0}^{m - 1} {H}_{L} ( {z}_{h}^{{2}^{k}} ) {\prod }_{k = 0}^{m - 2} {H}_{L}^{2} ( {z}_{v}^{{2}^{k}} )\end{matrix} \} \\ = {\sqrt{2}}^{m - 1} {↓}_{{2}^{m}} \{ {}^{M} \tilde{Y} {\prod }_{k = 0}^{m - 1} {H}_{L} ( {z}_{h}^{{2}^{k}} ) {\prod }_{k = 0}^{m - 2} {H}_{L}^{2} ( {z}_{v}^{{2}^{k}} ) \}\end{matrix} \qquad ( A .1 )$$

From the above non-recursive equation and the definition of ^{k-1}\tilde{Y} in (23), the recursive equation (25) can be obtained using:

$$\begin{matrix}{}_{LH}^{M - m} \tilde{Φ} = {↓}_{{2}^{m}} \{ {}^{M} \tilde{Y} {\sqrt{2}}^{m - 1} {\prod }_{k = 1}^{m - 1} {H}_{L} ( {z}_{h}^{{2}^{k}} ) {\prod }_{k = 0}^{m - 2} {H}_{L}^{2} ( {z}_{v}^{{2}^{k}} ) \} \\ = {↓}_{{2}^{m - 1}} \{ {}_{{2}^{m}} \{ \begin{matrix}{}^{M} \tilde{Y} {\sqrt{2}}^{m - 1} {H}_{L} ( {z}_{h}^{2} ) {H}_{L}^{2} ( {z}_{v}^{2} ) …… \\ {\prod }_{k = 2}^{m - 1} {H}_{L} ( {z}_{h}^{{2}^{k}} ) {\prod }_{k = 1}^{m - 2} {H}_{L}^{2} ( {z}_{v}^{{2}^{k}} )\end{matrix} \} \} \\ = {↓}_{{2}^{m - 1}} \{ \begin{matrix}{}_{{2}^{m}} {\{}^{M} \tilde{Y} \sqrt{2} {H}_{L} ( {z}_{h}^{2} ) {H}_{L}^{2} ( {z}_{v}^{2} ) \} … … \\ {\sqrt{2}}^{m - 2} {\prod }_{k = 1}^{m - 2} {H}_{L} ( {z}_{h}^{{2}^{k}} ) {\prod }_{k = 0}^{m - 3} {H}_{L}^{2} ( {z}_{v}^{{2}^{k}} )\end{matrix} \} \\ = {↓}_{{2}^{m - 1}} \{ {}^{M - 1} \tilde{Y} ( z ) {\sqrt{2}}^{m - 2} {\prod }_{k = 1}^{m - 2} {H}_{L} ( {z}_{h}^{{2}^{k}} ) {\prod }_{k = 0}^{m - 3} {H}_{L}^{2} ( {z}_{v}^{{2}^{k}} ) \} \\ ⋮ \\ = {↓}_{2} \{ {}^{M - m - 1} \tilde{Y} ( z ) \}\end{matrix} \qquad ( A .2 )$$

Starting from (A.1) in the first line of (A.2) the low pass filters are factored out of the product operators in the second line. In the third line, the order of down-sampling is adjusted, which modifies the initial and final values of the product indices. In the fourth line, ^{M-1}\tilde{Y} is substituted using (23) which leads to an equation which is the same as the first line of (A.2) with m→m−1 and M→M−1. Repeating this circular process leads to the last line of (A.2) which after the substitution m=M−k+2 becomes (25).

This shows that for the computation of _{LH}^{M-2}\tilde{Φ}, ^{M-1}\tilde{Y} is computed first by filtering ^{M}\tilde{Y} and then this data is down-sampled to produce _{LH}^{M-2}\tilde{Φ}. In the next iteration, the computation of _{LH}^{M-2}\tilde{Φ} can start with ^{M-1}\tilde{Y} which is available from the previous step, rather than begin with ^{M}\tilde{Y}.

The derivation of (26) can be carried out in a similar way. From (17) and the definition of ^{M}\tilde{X} follows that

$$\begin{matrix}{}_{HL}^{M - m} \tilde{Φ} = {↓}_{{2}^{m}} \{ {}^{M} Φ {H}_{H} ( {z}_{v}^{{2}^{m - 1}} ) {\prod }_{k = 0}^{m - 2} {H}_{L} ( {z}_{h}^{{2}^{k}} ) {\prod }_{k = 0}^{m - 1} {H}_{L} ( {z}_{v}^{{2}^{k}} ) \} \\ = {↓}_{{2}^{m}} \{ \begin{matrix}{}^{M} Φ {\sqrt{2}}^{m - 1} {H}_{H} ( {z}_{h} ) {\prod }_{k = 0}^{m - 2} {H}_{L} ( {z}_{v}^{{2}^{k}} ) … … \\ {\prod }_{k = 0}^{m - 2} {H}_{L} ( {z}_{h}^{{2}^{k}} ) {H}_{L} ( {z}_{v} ) {\prod }_{k = 1}^{m - 1} {H}_{L} ( {z}_{v}^{{2}^{k}} )\end{matrix} \} \\ = {\sqrt{2}}^{m - 1} {↓}_{{2}^{m}} \{ {}^{M} \tilde{X} {\prod }_{k = 0}^{m - 2} {H}_{L}^{2} ( {z}_{h}^{{2}^{k}} ) {\prod }_{k = 1}^{m - 1} {H}_{L} ( {z}_{v}^{{2}^{k}} ) \}\end{matrix} \qquad ( A .3 )$$

which, using the definition of ^{k-1}\tilde{X} in (24), leads to (26) in a similar way as with (25) from (A.2). Then (27) can be obtained by developing a non-recursive form of (18) which involves the available gradient data ^{M}\tilde{X} instead of the image data ^{M}φ:

$$\begin{matrix}{}_{HH}^{M - m} \tilde{Φ} = {↓}_{{2}^{m}} \{ {}^{M} Φ {H}_{H} ( {z}_{h}^{{2}^{m - 1}} ) {H}_{H} ( {z}_{v}^{{2}^{m - 1}} ) {\prod }_{k = 0}^{m - 2} {H}_{L} ( {z}_{h}^{{2}^{k}} ) {\prod }_{k = 0}^{m - 2} {H}_{L} ( {z}_{v}^{{2}^{k}} ) \} \\ = {↓}_{{2}^{m}} \{ \begin{matrix}{}^{M} Φ {\sqrt{2}}^{m - 1} {H}_{H} ( {z}_{h} ) {\prod }_{k = 0}^{m - 2} {H}_{L} ( {z}_{v}^{{2}^{k}} ) … … \\ {\prod }_{k = 0}^{m - 2} {H}_{L} ( {z}_{h}^{{2}^{k}} ) {H}_{H} ( {z}_{v}^{{2}^{m - 1}} ) {H}_{L} ( {z}_{v} ) {\prod }_{k = 1}^{m - 2} {H}_{L} ( {z}_{v}^{{2}^{k}} )\end{matrix} \} \\ = {\sqrt{2}}^{m - 1} {↓}_{{2}^{m}} \{ {}^{M} \tilde{X} {\prod }_{k = 0}^{m - 2} {H}_{L}^{2} ( {z}_{h}^{{2}^{k}} ) {H}_{H} ( {z}_{v}^{{2}^{m - 1}} ) {\prod }_{k = 1}^{m - 2} {H}_{L} ( {z}_{v}^{{2}^{k}} ) \}\end{matrix} \qquad ( A .4 )$$

and use the approach in (A.2) to obtain the recursive (27).
HH quadrant: To obtain the equations for the HH quadrant, _{HH}^{M-1}φ is decomposed with an M−1-stage HWAF to the form shown in FIG. 6. This implies that _{LL}^{M-m}\hat{φ} is obtained by applying (15) to _{HH}^{M-1}φ. Then _{HH}^{M-1}φ, is substituted in this expression using (18) and after changing the order of down-sampling one obtains the following equation:

$$\begin{matrix}{}_{LL}^{M - m} \hat{Φ} = {↓}_{{2}^{m - 1}} \{ {}_{HH}^{M - 1} Φ {\prod }_{k = 0}^{m - 2} {H}_{L} ( {z}_{h}^{{2}^{k}} ) {\prod }_{k = 0}^{m - 2} {H}_{L} ( {z}_{v}^{{2}^{k}} ) \} \\ = {↓}_{{2}^{m - 1}} \{ \begin{matrix}{}_{2} \{ {}^{M} Φ {H}_{H} ( {z}_{h} ) {H}_{L} ( {z}_{v} ) \} … … \\ {\prod }_{k = 0}^{m - 2} {H}_{L} ( {z}_{h}^{{2}^{k}} ) {\prod }_{k = 0}^{m - 2} {H}_{L} ( {z}_{v}^{{2}^{k}} )\end{matrix} \} \\ = {↓}_{{2}^{m}} \{ {}^{M} Φ {H}_{H} ( {z}_{h} ) {H}_{H} ( {z}_{v} ) {\prod }_{k = 1}^{m - 1} {H}_{L} ( {z}_{h}^{{2}^{k}} ) {\prod }_{k = 1}^{m - 1} {H}_{L} ( {z}_{v}^{{2}^{k}} ) \}\end{matrix} \qquad ( A .5 )$$

Equations (A.6) to (A.8) are obtained following similar operations as in (A.5)

$$\begin{matrix}{}_{LH}^{M - m} \hat{Φ} = {↓}_{{2}^{m}} \{ \begin{matrix}{}^{M} Φ {H}_{H} ( {z}_{h} ) {H}_{L} ( {z}_{v} ) {H}_{H} ( {z}_{v}^{{2}^{m - 1}} ) … … \\ {\prod }_{k = 1}^{m - 1} {H}_{L} ( {z}_{h}^{{2}^{k}} ) {\prod }_{k = 1}^{m - 2} {H}_{L} ( {z}_{v}^{{2}^{k}} )\end{matrix} \} & ( A .6 ) \\ {}_{HL}^{M - m} \hat{Φ} = {↓}_{{2}^{m}} \{ \begin{matrix}{}^{M} Φ {H}_{H} ( {z}_{h} ) {H}_{H} ( {z}_{v} ) {H}_{H} ( {z}_{h}^{{2}^{m - 1}} ) … … \\ {\prod }_{k = 1}^{m - 2} {H}_{L} ( {z}_{h}^{{2}^{k}} ) {\prod }_{k = 1}^{m - 1} {H}_{L} ( {z}_{v}^{{2}^{k}} )\end{matrix} \} & ( A 7 ) \\ {}_{HH}^{M - m} \hat{Φ} = {↓}_{{2}^{m}} \{ \begin{matrix}{}^{M} Φ {H}_{H} ( {z}_{h} ) {H}_{H} ( {z}_{v} ) {H}_{H} ( {z}_{h}^{{2}^{m - 1}} ) … … \\ {H}_{H} ( {z}_{v}^{{2}^{m - 1}} ) {\prod }_{k = 1}^{m - 2} {H}_{L} ( {z}_{h}^{{2}^{k}} ) {\prod }_{k = 1}^{m - 2} {H}_{L} ( {z}_{v}^{{2}^{k}} )\end{matrix} \} & ( A .8 )\end{matrix}$$

From (A.6) to (A.8), (A.9) to (A.10) follow by substituting (16) to (18) in the same manner as in (A.1), (A.3) and (A.4):

$$\begin{matrix}{}_{LH}^{M - m} \hat{Φ} = {↓}_{{2}^{m}} \{ {}^{M} \tilde{X} {H}_{H}^{2} ( {z}_{v} ) {\sqrt{2}}^{m - 1} {\prod }_{k = 1}^{m - 1} {H}_{L} ( {z}_{h}^{{2}^{k}} ) {\prod }_{k = 1}^{m - 2} {H}_{L}^{2} ( {z}_{v}^{{2}^{k}} ) \} & ( A .9 ) \\ {}_{HL}^{M - m} \hat{Φ} = {↓}_{{2}^{m}} \{ {}^{M} \tilde{Y} {H}_{H}^{2} ( {z}_{h} ) {\sqrt{2}}^{m - 1} {\prod }_{k = 1}^{m - 2} {H}_{L}^{2} ( {z}_{h}^{{2}^{k}} ) {\prod }_{k = 1}^{m - 1} {H}_{L} ( {z}_{v}^{{2}^{k}} ) \} & ( A .10 ) \\ \begin{matrix}{}_{HH}^{M - m} \hat{Φ} = {↓}_{{2}^{m}} \{ \begin{matrix}{}^{M} \tilde{X} {H}_{H} ( {z}_{h}^{{2}^{m - 1}} ) {H}_{H}^{2} ( {z}_{v} ) … … \\ {\sqrt{2}}^{m - 1} {\prod }_{k = 1}^{m - 2} {H}_{L} ( {z}_{h}^{{2}^{k}} ) {\prod }_{k = 1}^{m - 2} {H}_{L}^{2} ( {z}_{v}^{{2}^{k}} )\end{matrix} \} \\ = {↓}_{{2}^{m}} \{ \begin{matrix}{}^{M} \tilde{Y} {H}_{H}^{2} ( {z}_{h} ) {H}_{H} ( {z}_{v}^{{2}^{m - 1}} ) … … \\ {\sqrt{2}}^{m - 1} {\prod }_{k = 1}^{m - 2} {H}_{L}^{2} ( {z}_{h}^{{2}^{k}} ) {\prod }_{k = 1}^{m - 2} {H}_{L} ( {z}_{v}^{{2}^{k}} )\end{matrix} \}\end{matrix} & ( A .11 )\end{matrix}$$

The recursive form of (29) to (33) follow from (A.9) to (A.11) in a similar way as obtaining (26) from (A.2).

1. A method for reconstructing a digital image comprising:
obtaining gradient data of said digital image;
performing a first computer process to generate a wavelet decomposition of said digital image based on said gradient data and providing a first result to a second computer process;
performing a synthesis and smoothing operation on decomposed gradient data in said second computer process to provide an estimate of pixel intensities from said wavelet decomposition; and
outputting a second result of said second computer process;
wherein said second result is a reconstructed digital image.

2. A method as claimed in claim 1, wherein down sampling is performed on said gradient data prior to generating said wavelet decomposition.

3. A method as claimed in claim 2, wherein said wavelet decomposition is a Haar wavelet decomposition.

4. A method as claimed in claim 1, wherein said synthesis and smoothing operation is a Haar wavelet synthesis filtering operation followed by a smoothing operation.

5. A method as claimed in claim 4, wherein said smoothing operation includes averaging gradients of an image estimate with said gradient data.

6. A method as claimed in claim 1, wherein said digital image is a grayscale digital image.

7. A method as claimed in claim 1, wherein said digital image is a colored digital image.

8. A method as claimed in claim 1, wherein a coarse approximation of the gradient data is obtained for a view finder of a camera that includes fewer pixels than said camera.

9. A method as claimed in claim 1, wherein said gradient data is provided in a square data set.

10. A method as claimed in claim 9, wherein non-square data sets are extrapolated into square data sets using a reflection method.

11. A method as claimed in claim 1, wherein said method is applied to a plurality of data sets representing a grayscale.

12. A method as claimed in claim 1, wherein method is applied to a plurality of data sets representing a color.

13. A method as claimed in claim 1, wherein said reconstructed digital image is outputted to a device selected from the group consisting of: an image-displaying device, an image-capturing device, an image-replicating device and an image-storing device.

14. A computer-readable medium comprising instructions executable on a processor for implementing the method of claim 1.

15. A method as claimed in claim 1, wherein said gradient data is obtained from a sensor capable of directly measuring the difference in light power between two neighboring pixels.

16. A method as claimed in claim 1, wherein said gradient data is obtained by computing the difference in intensities of neighboring pixels of a digital image.

17. An image-generating device comprising:
an image sensing device for generating a digital image;
a processor in communication with said image sensing device, said processor for calculating gradient data based on said digital image, generating a wavelet decomposition of said digital image based on said gradient data and performing a synthesis and smoothing operation on decomposed gradient data to provide an estimate of pixel intensities from said wavelet decomposition;
an image output device in communication with said processor for outputting a reconstructed digital image.

18. An image capturing device as claimed in claim 17, wherein said output device is a view finder.

19. An image capturing device as claimed in claim 17, wherein said output device is an image storage device.

20. An image capturing device as claimed in claim 17, wherein said image capturing device is a camera.
